(19) United States
(12) Patent Application Publication
(10) Pub. No.: US 2019/0215583 A1
(43) Pub. Date: Jul. 11, 2019

(54) METHOD AND SYSTEM OF FLEET MANAGEMENT OF SHADING DEVICES

(71) Applicant: Shadecraft, Inc., Pasadena, CA (US)

(72) Inventor: Armen Sevada Gharabegian, Glendale, CA (US)

(21) Appl. No.: 16/008,000

(22) Filed: Jun. 13, 2018

Related U.S. Application Data
(60) Provisional application No. 62/665,498, filed on May 1, 2018.
(60) Provisional application No. 62/670,646, filed on May 11, 2018.
(60) Provisional application No. 62/614,403, filed on Jan. 6, 2018.

(51) Int. Cl. H04Q 9/00; E04H 15/02; H04W 4/80; G08C 17/02; G05B 15/02

(52) U.S. Cl. CPC H04Q 9/00; E04H 15/02; H04W 4/80; G08C 17/02; H04N 5/23206; H04Q 2213/065; G08C 2201/31; H04Q 2209/43; G05B 15/02

(57) ABSTRACT

A mobile communications device to control two or more umbrellas includes one or more wireless communication transceivers, one or more processing devices, one or more memory device and computer-readable instructions executable by the one or more processors to perform a number of actions. The actions performed are to create a list of umbrellas associated with the mobile communications device; receive a selection of at least a first umbrella and a second umbrella to be assigned as a first umbrella group; assign the first umbrella and the second umbrella as the first umbrella group; receive a selection of commands, instructions, parameters or messages to be communicated to the first umbrella group; and communicate, via a wireless transceiver of the one or more wireless transceivers the selected commands, parameters, instructions or messages to a first umbrella and to a second umbrella.

### RELATED APPLICATIONS

This application is related to and claims priority to U.S. provisional patent application Ser. No. 62/614,403, filed Jan. 6, 2018, entitled “Umbrella Parasol or Shading System Mechanical Improvements and Artificial Intelligence Methods,” U.S. provisional application Ser. No. 62/665,498, filed May 1, 2018, entitled “Modular Umbrella or Parasol,” and U.S. provisional application Ser. No. 62/670,646, filed May 11, 2018, entitled “Robotic Shading Devices, Shading Devices Utilizing Artificial Intelligence, Fleet Management Of Shading Devices And IoT-Enabled Shading Devices, the disclosures of which are all hereby incorporated by reference.

### BACKGROUND

Umbrellas, parasols, shading systems, lighting systems and voice-activated hubs (all of which may be referred to as shading devices) may utilize arms, blades and/or a frame along with shading fabric to provide to cover individuals standing beneath or in an area covered by the shading device. Prior art systems utilized threaded nuts and a collared frame extension or expansion assembly to expand or retract arms or blades and/or frames to open and/or closed positions. However, such prior art systems take up a lot of space and have a number of linkage assemblies that may lead to pieces malfunctioning or being broken more easily.

### BRIEF DESCRIPTION OF DRAWINGS

FIGS. 1A, 1B and 1C illustrate a shading device according to embodiments;

FIG. 2A illustrates a block diagram of an intelligent shading device according to embodiments;

FIG. 2B illustrates an additional shading device in a closed position (e.g., the arms or blades are in a closed or retracted position) according to embodiments;

FIG. 2C illustrates an additional shading device in a deployed position (e.g., the arms or blades are in a deployed or open position);

FIG. 3A illustrates a flowchart outlining a process for controlling a shading device according to embodiments;

FIG. 3B illustrates a mobile communications device (or other computing device) communicating with a plurality of shading devices according to embodiments;

FIG. 4A illustrates an initial selection screen in fleet management software according to embodiments;

FIG. 4B illustrates a shading device type selection screen according to embodiments;

FIG. 4C illustrates different ways or processes for communicating commands, instructions, messages and/or parameters to the plurality of shading devices;

FIG. 4D illustrates an input screen for an operator to create one or more shading device groups according to embodiments;

FIG. 4E illustrates another shading device control menu or web page for a selected shading device group according to embodiments;

FIG. 4F illustrates a screen of a mobile communication device operating fleet management software and receiving video or images from two or more shading devices according to embodiments;

FIG. 4G illustrates a screen of a mobile communication device operating fleet management software and receiving status measurements and/or parameters from two or more shading devices according to embodiments;

FIG. 5A illustrates a block diagram of an intelligence housing and components housed therein according to embodiments;

FIG. 5B illustrates a block diagram power subsystem of a parasol, umbrella or shading system according to embodiments; and

FIG. 6 illustrates a computing device according to embodiments

### DETAILED DESCRIPTION OF THE INVENTION

The foregoing, and other features and advantages of the invention, will be apparent from the following, more particular description of the preferred embodiments of the invention, the accompanying drawings, and the claims. In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

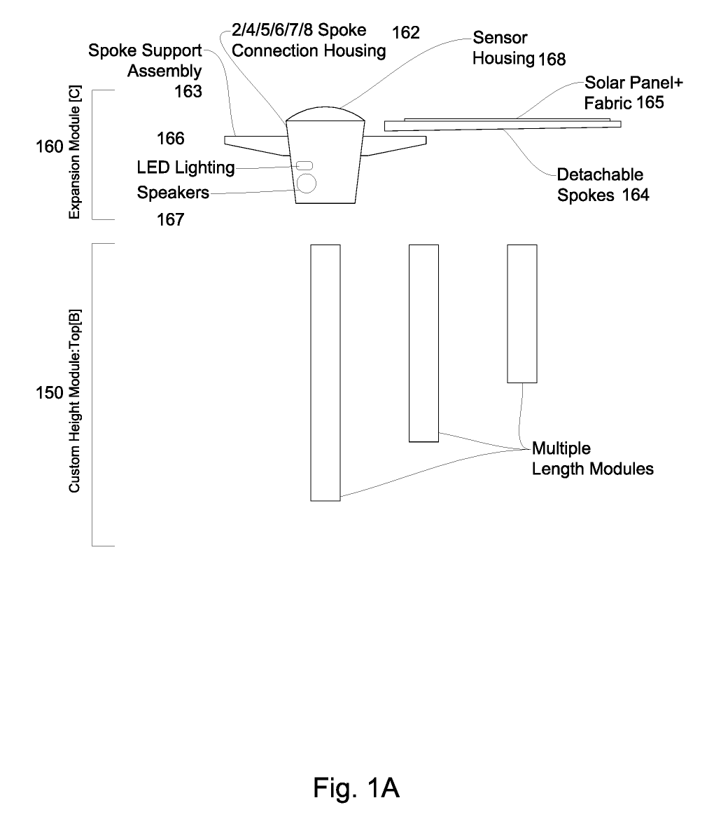

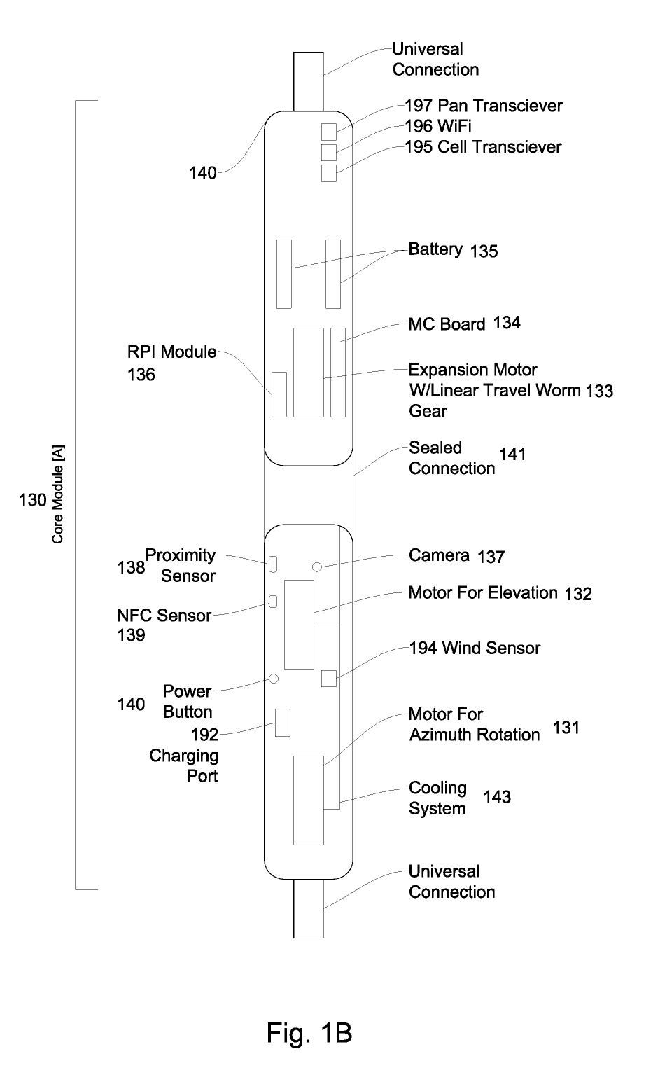

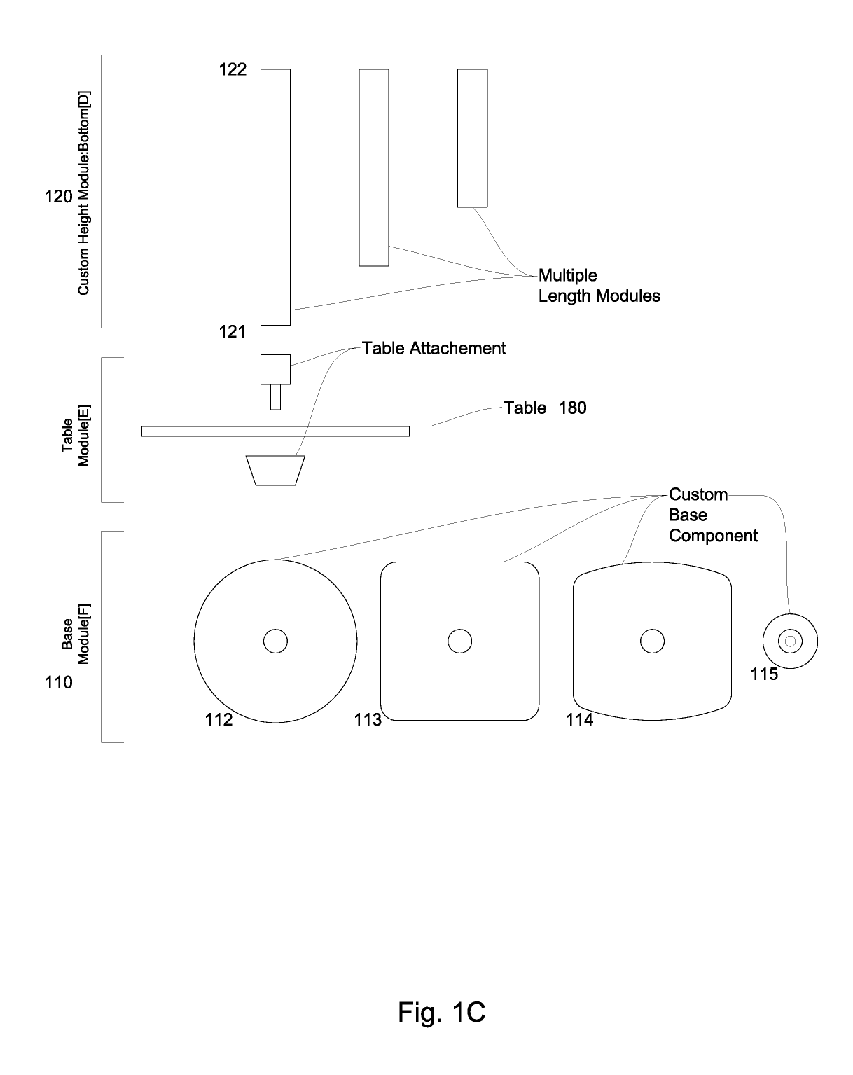

FIGS. 1A, 1B and 1C illustrate a modular umbrella shading system according to embodiments. In embodiments, a modular umbrella system 100 comprises a base assembly or module 110, a first extension assembly or module 120, a core assembly module housing (or core umbrella assembly) 130, a second extension assembly or module 150, and an expansion sensor assembly or module (or an arm extension assembly or module) 160. In embodiments, a modular umbrella shading system 100 may not comprise a base assembly or module 110 and may comprise a table assembly or module 180 to connect to table tops, such as patio tables and/or other outdoor furniture. In embodiments, a table assembly or module 180 may comprise a table attachment and/or a table receptacle. In embodiments, a base module or assembly 110 may comprise a circular base component 112, a square or rectangular base component 113, a rounded edges base component 114, and/or a beach or sand base component 115. In embodiments, base components 112, 113, 114, and/or 115 may be interchangeable based upon a configuration required by an umbrella system and/or user. In embodiments, each of the different options for the base components 112, 113, 114, 115, and/or 180 may have a universal connector and/or receptacle to allow for easy interchangeability.

In embodiments, a first extension assembly or module 120 may comprise a shaft assembly having a first end 121 and a second end 122. In embodiments, a first end 121 may be detachably connectable and/or connected to a base assembly or module 110. In embodiments, a second end 122 may be detachably connected and/or connectable to a first end of a core umbrella assembly or module 130. In embodiments, a first end 121 and a second end 122 may have a universal umbrella connector. In other words, a connector may be universal within all modules and/or assemblies of a modular umbrella system to provide a benefit of allowing backwards capabilities with new versions of different modules and/or assemblies of a modular umbrella shading system. In embodiments, a first extension assembly or module 120 may have different lengths. In embodiments, different length first extension assemblies may allow a modular umbrella shading system to have different clearance heights between a base assembly or module 110 and/or a core umbrella assembly or module 130. In embodiments, a first extension assembly or module 110 may be a tube and/or a shell with channels, grooves and/or pathways for electrical wires and/or components and/or mechanical components. In embodiments, a first extension assembly 110 may be a shaft assembly having an inner core comprising channels, grooves and/or pathways for electrical wires, connectors and/or components and/or mechanical components.

In embodiments, a universal umbrella connector or connection assembly 124 may refer to a connection pair and/or connection assembly that may be uniform for all modules, components and/or assemblies of a modular umbrella system 100. In embodiments, having a universal umbrella connector or connection assembly 124 may allow interchangeability and/or backward compatibility of the various assemblies and/or modules of the modular umbrella system 100. In embodiments, for example, a diameter of all or most of universal connectors 124 utilized in a modular umbrella system may be the same. In embodiments, a universal connector or connection assembly 124 may be a twist-on connector. In embodiments, a universal connector 124 may be a drop in connector and/or a locking connector, having a male and female connector. In embodiments, a universal connector or connection assembly 124 may be a plug with another connector being a receptacle. In embodiments, universal connector 124 may be an interlocking plug receptacle combination. For example, universal connector 124 may be a plug and receptacle, jack and plug, flanges for connection, threaded plugs and threaded receptacles, snap fit connectors, adhesive or friction connectors. In embodiments, for example, universal connector or connection assembly 124 may be external connectors engaged with threaded internal connections, snap-fit connectors, push fit couplers. In embodiments, by having a universal connector or connection assembly 124 for joints or connections between a base module or assembly 110 and a first extension module or assembly 120, a first extension module or assembly 120 and a core assembly module or assembly 130, a core assembly module or assembly 130 and a second extension module or assembly 150, and/or a second extension module or assembly 150 and an expansion sensor module or assembly 160, an umbrella or shading object manufacturer may not need to provide additional parts for additional connectors for attaching, coupling or connecting different modules or assemblies of a modular umbrella shading system. In addition, modules and/or assemblies may be upgraded easily because one module and/or assembly may be switched out of a modular umbrella system without having to purchase or procure additional modules because of the interoperability and/or interchangeability.

In embodiments, a core umbrella assembly or module 130 may be positioned between a first extension assembly or module 120 and a second extension assembly or module 150. In embodiments, core umbrella assembly or module 130 may be positioned between a base assembly or module 110 and/or an expansion and sensor module or assembly 160. In embodiments, a core umbrella assembly or module 130 may comprise an upper core assembly 140, a core assembly connector or mid-section 141 and/or a lower core assembly 142. In embodiments, a core assembly connector 141 may be a sealer or sealed connection to protect a modular umbrella system from environmental conditions. In embodiments, a core umbrella assembly or module 130 may comprise two or more motors or motor assemblies. Although the specification may refer to a motor, a motor may be a motor assembly with a motor controller, a motor, a stator, a rotor and/or a drive/output shaft. In embodiments, a core umbrella assembly 130 may comprise an azimuth rotation motor 131, an elevation motor 132, and/or a spoke expansion/retraction motor 133. In embodiments, an azimuth rotation motor 131 may cause a core umbrella assembly 130 to rotate clockwise or counterclockwise about a base assembly or module 110 or a table connection assembly 180. In embodiments, an azimuth rotation motor 131 may cause a core umbrella assembly 130 to rotate about an azimuth axis. In embodiments, a core umbrella assembly or module 130 may rotate up to 360 degrees with respect to a base assembly or module 130.

In embodiments, an elevation motor 132 may cause an upper core assembly 140 to rotate with respect to a lower core assembly 142. In embodiments, an elevation motor 130 may rotate an upper core assembly 140 between 0 to 90 degrees with respect to the lower core assembly 142. In embodiments, an elevation motor 130 may rotate an upper module or assembly 140 between 0 to 30 degrees with respect to a lower assembly or module 142. In embodiments, an original position may be where an upper core assembly 140 is positioned in line and above the lower core assembly 142, as is illustrated in FIGS. 1A, 1 B and 1C.

In embodiments, a spoke expansion motor 133 may be connected to an expansion and sensor assembly module 160 via a second extension assembly or module 150 and cause spoke or arm support assemblies in a spoke expansion sensor assembly module 160 to deploy or retract outward and/or upward from an expansion sensor assembly module 160. In embodiments, an expansion extension assembly module 160 may comprise a rack gear and spoke connector assemblies (or arms). In embodiments, a spoke expansion motor 133 may be coupled and/or connected to a hollow tube via a gearing assembly, and may cause a hollow tube to move up or down (e.g., in a vertical direction). In embodiments, a hollow tube may be connected and/or coupled to a rack gear, which may be connected and/or coupled to spoke connector assemblies. In embodiments, movement of a hollow tube in a vertical direction may cause spoke assemblies and/or arms to be deployed and/or retracted. In embodiments, spoke connector assemblies and/or arms may have a corresponding and/or associated gear at a vertical rack gear.

In embodiments, a core assembly or module 130 may comprise motor control circuitry 134 (e.g., a motion control board 134) that controls operation of an azimuth motor 131, an elevation motor 132 and/or an expansion motor 133, along with other components and/or assemblies. In embodiments, the core assembly module 130 may comprise one or more batteries 135 (e.g., rechargeable batteries) for providing power to electrical and mechanical components in the modular umbrella system 100. For example, one or more batteries 135 may provide power to motion control circuitry 134, an azimuth motor 131, an expansion motor 133, an elevation motor 132, a camera 137, a proximity sensor 138, a near field communication (NFC) sensor 138. In embodiments, one or more batteries 135 may provide power to an integrated computing device 136, although in other embodiments, an integrated computing device 136 may also comprise its own battery (e.g., rechargeable battery).

In embodiments, the core assembly 130 may comprise a separate and/or integrated computing device 136. In embodiments, a separate computing device 136 may comprise a Raspberry Pi computing device, other single-board computers and/or single-board computing device. Because a modular umbrella shading system has a limited amount of space, a single-board computing device is a solution that allows for increased functionality without taking up too much space in an interior of a modular umbrella shading system. In embodiments, a separate computing device 136 may handle video, audio and/or image editing, processing, and/or storage for a modular umbrella shading system 100 (which are more data intensive functions and thus require more processing bandwidth and/or power). In embodiments, an upper core assembly 140 may comprise one or more rechargeable batteries 135, a motion control board (or motion control circuitry) 134, a spoke expansion motor 133 and/or a separate and/or integrated computing device 136.

In embodiments, a core assembly connector/cover 141 may cover and/or secure a connector between an upper core assembly 140 and a lower core assembly 142. In embodiments, a core assembly connector and/or cover 141 may provide protection from water and/or other environmental conditions. In other words, a core assembly connector and/or cover 141 may make a core assembly 130 waterproof and/or water resistant and in other environments, may protect an interior of a core assembly from sunlight, cold or hot temperatures, humidity and/or smoke. In embodiments, a core assembly connector/cover 141 may be comprised of a rubber material, although a plastic and/or fiberglass material may be utilized. In embodiments, a core assembly connector/cover 141 may be comprised of a flexible material, silicone, and/or a membrane In embodiments, a core assembly connector/cover 141 may be circular and/or oval in shape and may have an opening in a middle to allow assemblies and/or components to pass freely through an interior of a core assembly connector or cover 141. In embodiments, a core assembly connector/cover 141 may adhere to an outside surface of an upper core assembly 140 and a lower core assembly 142. In embodiments, a core assembly connector/cover 141 may be connected, coupled, fastened and/or have a grip or to an outside surface of the upper core assembly 140 and the lower core assembly 142. In embodiments, a core assembly connector and/or cover 141 may be connected, coupled, adhered and/or fastened to a surface (e.g., top or bottom surface) of an upper core assembly and/or lower core assembly 142. In embodiments, a core assembly connector/cover 141 may cover a hinging assembly and/or reparation point, springs, and wires that are present between an upper core assembly 140 and/or a lower core assembly 142.

In embodiments, a core assembly or module 130 may comprise one or more cameras 137. In embodiments, one or more cameras 137 may be capture images, videos and/or sound of an area and/or environment surrounding a modular umbrella system 100. In embodiments, a lower core assembly 142 may comprise one or more cameras 137. In embodiments, a camera 137 may only capture sound if a user selects a sound capture mode on a modular umbrella system 100 (e.g., via a button and/or switch) or via a software application controlling operation of a modular umbrella system (e.g., a microphone or recording icon is selected in a modular umbrella system software application).

In embodiments, a core assembly 130 may comprise a power button to manually turn on or off power to components of a modular umbrella system. In embodiments, a core assembly or module 130 may comprise one or more proximity sensors 138. In embodiments, one or more proximity sensors 138 may detect whether or not an individual and/or subject may be within a known distance from a modular umbrella system 100. In embodiments, in response to a detection of proximity of an individual and/or subject, a proximity sensor 138 may communicate a signal, instruction, message and/or command to motion control circuitry (e.g., a motion control PCB 134) and/or a computing device 136 to activate and/or deactivate assemblies and components of a modular umbrella system 100. In embodiments, a lower core assembly 142 may comprise a proximity sensor 138 and a power button. For example, a proximity sensor 138 may detect whether an object is within proximity of a modular umbrella system and may communicate a message to a motion control PCB 134 to instruct an azimuth motor 131 to stop rotating a base assembly or module.

In embodiments, a core assembly or module 130 may comprise a near-field communication (NFC) sensor 139. In embodiments, a NFC sensor 139 may be utilized to identify authorized users of a modular umbrella shading system 100. In embodiments, for example, a user may have a mobile computing device with a NFC sensor which may communicate, pair and/or authenticate in combination with a modular umbrella system NFC sensor 139 to provide user identification information. In embodiments, a NFC sensor 139 may communicate and/or transmit a signal, message, command and/or instruction based on a user's identification information to computer-readable instructions resident within a computing device and/or other memory of a modular umbrella system to verify a user is authenticated and/or authorized to utilize a modular umbrella system 100.

In embodiments, a core assembly or module 130 may comprise a cooling system and/or heat dissipation system 143. In embodiments, a cooling system 143 may be one or more channels in an interior of a core assembly or module 130 that direct air flow from outside a modular umbrella system across components, motors, circuits and/or assembles inside a core assembly 130. For example, one or more channels and/or fins may be coupled and/or attached to components, motors and/or circuits, and air may flow through channels to fins and/or components, motors and/or circuits. In embodiments, a cooling system 143 may lower operating temperatures of components, motors, circuits and/or assemblies of a modular umbrella system 100. In embodiments, a cooling system 143 may also comprise one or more plates and/or fins attached to circuits, components and/or assemblies and also attached to channels to lower internal operating temperatures. In embodiments, a cooling system 143 may also move hot air from electrical and/or mechanical assemblies to outside a core assembly. In embodiments, a cooling system 143 may be fins attached to or vents in a body of a core assembly 130. In embodiments, fins and/or vents of a cooling system 143 may dissipate heat from electrical and mechanical components and/or assemblies of the core module or assembly 130.

In embodiments, a separate, detachable and/or connectable skin may be attached, coupled, adhered and/or connected to a core module assembly 130. In embodiments, a detachable and/or connectable skin may provide additional protection for a core assembly module against water, smoke, wind and/or other environmental conditions and/or factors. In embodiments, a skin may adhere to an outer surface of a core assembly.130. In embodiments, a skin may have a connector on an inside surface of the skin and core assembly 130 may have a mating receptacle on an outside surface. In embodiments, a skin may magnetically couple to a core assembly 130. In embodiments, a skin may be detachable and removable from a core assembly so that a skin may be changed for different environmental conditions and/or factors. In embodiments, a skin may connect to an entire core assembly. In embodiments, a skin may connect to portions of an upper core assembly 140 and/or a lower core assembly 142. In embodiments, a skin may not connect to a middle portion of a core assembly 130 (or a core assembly cover connector 141). In embodiments, a skin may be made of a flexible material to allow for bending of a modular umbrella system 100. In embodiments, a base assembly 110, a first extension assembly 120, a core module assembly 130, a second extension assembly 140 and/or an arm extension and sensor assembly 160 may also comprise one or more skin assemblies. In embodiments, a skin assembly may provide a cover for a majority of all of a surface area one or more of the base assembly, first extension assembly 120, core module assembly 130, second extension assembly 150 and/or arm extension sensor assembly 160. In embodiments, a core assembly module 130 may further comprise channels on an outside surface. In embodiments, a skin assembly may comprise two pieces. In embodiments, a skin assembly may comprise edges and/or ledges. In embodiments, edges and/or ledges of a skin assembly may be slid into channels of a core assembly module 130. In embodiments, a base assembly 110, a first extension assembly 120, a second extension assembly 140 and/or an arm expansion sensor assembly 160 may also comprise an outer skin assembly. In embodiments, skin assemblies for these assemblies may be uniform to present a common industrial design. In embodiments, skin assemblies may be different if such as a configuration is desired by a user. In embodiments, skin assemblies may be comprise of a plastic, a hard plastic, fiberglass, aluminum, other light metals (including aluminum), and/or composite materials including metals, plastic, wood. In embodiments, a core assembly module 130, a first extension assembly 120, a second extension assembly 150, an arm expansion sensor assembly 160, and/or a base assembly 110 may be comprised of aluminum, light metals, plastic, hard plastics, foam materials, and/or composite materials including metals, plastic, wood. In embodiments, a skin assembly may be provide protection from environmental conditions (such as sun, rain, and/or wind).

In embodiments, a second extension assembly 150 connects and/or couples a core assembly module 130 to an expansion assembly sensor module (and/or arm extension assembly module) 160. In embodiments, an expansion sensor assembly module 160 may have universal connectors and/or receptacles on both ends to connect or couple to universal receptacles and/or connectors, on the core assembly 130 and/or expansion sensor assembly module 160. FIGS. 1A, 1B, and 1C illustrate that a second extension assembly or module 150 may have three lengths. In embodiments, a second extension assembly 150 may have one of a plurality of lengths depending on how much clearance a user and/or owner may like to have between a core assembly module 130 and spokes of an expansion sensor assembly or module 160. In embodiments, a second extension assembly or module 150 may comprise a hollow tube and/or channels for wires and/or other components that pass through the second extension assembly or module 150. In embodiments, a hollow tube 249 may be coupled, connected and/or fixed to a nut that is connected to, for example, a threaded rod (which is part of an expansion motor assembly). In embodiments, a hollow tube 249 may be moved up and down based on movement of the threaded rod. In embodiments, a hollow tube in a second extension assembly may be replaced by a shaft and/or rod assembly.

In embodiments, an expansion and sensor module 160 may be connected and/or coupled to a second extension assembly or module 150. In embodiments, an expansion and sensor assembly or module 160 may be connected and/or coupled to a second extension assembly or module 150 via a universal connector. In embodiments, an expansion and sensor assembly or module 160 may comprise an arm or spoke expansion sensor assembly 162 and a sensor assembly housing 168. In embodiments, an expansion and sensor assembly or module 160 may be connected to a hollow tube 249 and thus coupled to a threaded rod. In embodiments, when a hollow tube moves up and down, an arm or spoke expansion assembly 162 opens and/or retracts, which causes spokes/blades 164 of an arm extension assembly 163. In embodiments, arms, spokes and/or blades 164 may detachably connected to the arm or spoke support assemblies 163.

In embodiments, an expansion and sensor assembly module 160 may have a plurality of arms, spokes or blades 164 (which may be detachable or removable). Because the umbrella system is modular and/or adjustable to meet needs of user and/or environment, an arm or spoke expansion assembly 162 may not have a set number of arm, blade or spoke support assemblies 163. In embodiments, a user and/or owner may determine and/or configure a modular umbrella system 100 with a number or arms, spokes, or blades extensions 163 (and thus detachable spokes, arms and/or blades 164) necessary for a certain function and attach, couple and/or connect an expansion sensor assembly or module 160 with a spoke expansion assembly 162 with a desired number of blades, arms or spoke connections to a second extension module or assembly 150 and/or a core module assembly or housing 130. Prior umbrellas or shading systems utilize a set or established number of ribs and were not adjustable or configurable. In contrast, a modular umbrella system 100 described herein has an ability to have a detachable and adjustable expansion sensor module 162 comprising an adjustable number of arm/spoke/blade support assemblies or connections 163 (and therefore a flexible and adjustable number of arms/spokes/blades 164), which provides a user with multiple options in providing shade and/or protection. In embodiments, expansion and sensor expansion module 160 may be detachable or removable from a second extension module 150 and/or a core assembly module 130 and also one or more spokes, arms and/or assemblies 164 may be detachable or removable from arm or spoke support assemblies 163. Therefore, depending on the application or use, a user, operator and/or owner may detachably remove an expansion and sensor module or assembly 160 having a first number of arm/blade/spoke support assemblies 163 and replace it with a different expansion sensor module or assembly 160 having a different number of arm/blade/spoke support assemblies 163.

In embodiments, arms, blades and/or spokes 164 may be detachably connected and/or removable from one or more arm support assemblies 163. In embodiments, arms, blades, and/or spokes 164 may be snapped, adhered, coupled and/or connected to associated arm support assemblies 163. In embodiments, arms, blades and/or spokes 164 may be detached, attached and/or removed before deployment of the arm extension assemblies 163.

In embodiments, a shading fabric 165 may be connected, attached and/or adhered to one or more arm extension assemblies 163 and provide shade for an area surrounding, below and/or adjacent to a modular umbrella system 100. In embodiments, a shading fabric (or multiple shading fabrics) may be connected, attached, and/or adhered to one or more spokes, arms and/or blades 164. In embodiments, a shading fabric or covering 165 may have integrated therein, one or more solar panels and/or cells (not shown). In embodiments, solar panels and/or cells may generate electricity and convert the energy from a solar power source to electricity. In embodiments, solar panels may be coupled to a shading power charging system (not shown). In embodiments, one or more solar panels and/or cells may be positioned on top of a shading fabric 165. In embodiments, one or more solar panels and/or cells may be connected, adhered, positioned, attached on and/or placed on a shading fabric 165.

In embodiments, an expansion sensor assembly or module 160 may comprise one or more audio speakers 167. In embodiments, an expansion sensor assembly or module 160 may further comprise an audio/video transceiver. In embodiments, a core assembly 130 may comprise and/or house an audio/video transceiver (e.g., a Bluetooth or other PAN transceiver, such as Bluetooth transceiver 197). In embodiments, an expansion sensor assembly or module 160 may comprise an audio/video transceiver (e.g., a Bluetooth and/or PAN transceiver) In embodiments, an audio/video transceiver in an expansion sensor assembly or module 160 may receive audio signals from an audio/video transceiver 197 in a core assembly 130, convert to an electrical audio signal and reproduce the sound on one or more audio speakers 167, which projects sound in an outward and/or downward fashion from a modular umbrella system 100. In embodiments, one or more audio speakers 167 may be positioned and/or integrated around a circumference of an expansion sensor assembly or module 160.

In embodiments, an expansion sensor assembly or module 160 may comprise one or more LED lighting assemblies 166. In embodiments, one or more LED lighting assemblies 166 may comprise bulbs and/or LED lights and/or a light driver and/or ballast. In embodiments, an expansion sensor assembly or module 160 may comprise one or more LED lighting assemblies positioned around an outer surface of the expansion sensor assembly or module 160. In embodiments, one or more LED lighting assemblies 166 may drive one or more lights. In embodiments, a light driver may receive a signal from a controller or a processor in a modular umbrella system 100 to activate/deactivate LED lights. The LED lights may project light into an area surrounding a modular umbrella system 100. In embodiments, one or more lighting assemblies 166 may be recessed into an expansion or sensor module or assembly 160.

In embodiments, an arm expansion sensor housing or module 160 may also comprise a sensor housing 168. In embodiments, a sensor housing 168 may comprise one or more environmental sensors, one or more telemetry sensors, and/or a sensor housing cover. In embodiments, one or more environmental sensors may comprise one or more air quality sensors, one or more UV radiation sensors, one or more digital barometer sensors, one or more temperature sensors, one or more humidity sensors, one or more carbon monoxide sensors, one or more carbon dioxide sensors, one or more gas sensors, one or more radiation sensors, one or more interference sensors, one or more lightning sensors, one or more and/or one or more wind speed sensors. In embodiments, one or more telemetry sensors may comprise a GPS/GNSS sensor and/or one or more digital compass sensors. In embodiments, a sensor housing 168 may also comprise one or more accelerometers and/or one or more gyroscopes. In embodiments, a sensor housing 168 may comprise sensor printed circuit boards and/or a sensor cover (which may or may not be transparent). In embodiments, a sensor printed circuit board may communicate with one or more environmental sensors and/or one or more telemetry sensors (e.g., receive measurements and/or raw data), process the measurements and/or raw data and communicate sensor measurements and/or data to a motion control printed circuit board (e.g., controller) and/or a computing device (e.g., controller and/or processor). In embodiments, a sensor housing 168 may be detachably connected to an arm connection housing/spoke connection housing to allow for different combinations of sensors to be utilized for different umbrellas. In embodiments, a sensor cover of a sensor housing 168 may be clear and/or transparent to allow for sensors to be protected from an environment around a modular umbrella system. In embodiments, a sensor cover may be moved and/or opened to allow for sensors (e.g., air quality sensors to obtain more accurate measurements and/or readings). In embodiments, a sensor printed circuit board may comprise environmental sensors, telemetry sensors, accelerometers, gyroscopes, processors, memory, and/or controllers in order to allow a sensor printed circuit board to receive measurements and/or readings from sensors, process received sensor measurements and/or readings, analyze sensor measurements and/or readings and/or communicate sensor measurements and/or readings to processors and/or controllers in a core assembly or module 130 of a modular umbrella system 100.

In embodiments, a modular umbrella shading system 100 may comprise a lightning sensor. In embodiments, a lightning sensor may be installed on a base assembly 110. In embodiments, a lightning sensor may be installed on a core module or core assembly 130. In embodiments, a lightning sensor may be installed on a sensor and/or expansion assembly or module 160. In embodiments, a lightning sensor may be installed, attached, fastened and/or positioned on a shading fabric, an arm, and/or a blade of an intelligent shading system. In embodiments, a lightning sensor may be installed on and/or within a sensor housing 168. In embodiments, a lightning sensor may be installed on and/or connected, adhered or coupled to a skin of an intelligent umbrella and/or shading system. In embodiments, a lightning sensor may detect lightning conditions around an area or in a vicinity of an intelligent umbrella and/or shading system. In embodiments, a lightning sensor may detect an interference signal strength and/or pattern in an atmosphere that corresponds to either intra-cloud lightning conditions and/or occurrences, and/or to cloud-to-ground lightning conditions and/or occurrences. In embodiments, a lightning sensor may have tolerance conditions set. In embodiments, a lightning sensor may also able to measure and/or calculate a distance from a location with an intelligent shading system and/or intelligent umbrella to a location where a lightning event and/or condition has occurred. In embodiments, a lightning sensor may be an Austria Microsystems Franklin AS3935 digital lightning sensor. In embodiments, a lightning sensor may calculate signal measurements, signal strengths, other conditions (e.g., based at least on interference received with respect to lightning conditions) and/or distances, and may communicate signal measurements, signal strengths, other conditions and/or distances to a memory in an intelligent umbrella for storage. In embodiments, lightning sensor signal measurements, strengths, conditions and/or distances may be communicated to a computing device 136 where one or more processors may execute computer-readable instructions to 1) receive lightning sensor signal measurements, strength measurements, conditions and/or distances, 2) process such measurements and/or conditions; and 3) generate commands, instructions, messages and/or signals to cause actions by other components and/or assemblies in an intelligent umbrella and/or robotic shading system in response to measurements and/or conditions captured and/or received by a lightning sensor. In embodiments, computer-readable instructions fetched from one or more memory modules and executed by a processor of a computing device 136 may generate and communicate commands to a motion control board 134 to cause different motor assemblies to move assemblies (e.g., an upper portion of a core assembly and/or are support assemblies to extend arms) of an intelligent umbrella and/or shading system. In embodiments, because portions of an intelligent umbrella and/or shading system are metallic, computer-readable instructions executed by one or more processors may generate and communicate commands, messages, signals or instructions to cause an expansion and sensor assembly 160 to retract arms and/or spokes 164 to a rest or closed position and/or to turn off other sensors in a sensor housing to protect sensors from lightning strikes. In embodiments, because portions of an intelligent umbrella and/or shading system are metallic and conductive, computer-readable instructions executed by one or more processors may generate and communicate commands, messages, signals or instructions to cause an expansion and sensor assembly 160, a core assembly 130 and/or a base assembly to turn off or deactivate other components, motors, processors and/or sensors to prevent damage from electrical (voltage and/or current surges) in a sensor housing to protect sensors from lightning strikes. In embodiments, computer-readable instructions executed by a processor of a computing device 136 (or other processor/controller) may generate and communicate commands, messages, signals and/or instructions to a sound reproduction system (e.g., an audio receiver and/or speaker) to cause an alarm to be activated and/or a warning message to be reproduced and/or generate and communicate commands, messages, signals and/or instructions to a lighting system 166 to generate lights and/or rays indicating a dangerous situation is occurring or going to occur. In addition, because lightning strikes can damage electrical components, a lightning sensor's measurements, conditions and/or distances may be communicated to a processor and computer-readable instructions executed by one or more processors may generate and communicate commands to a power subsystem (e.g., a rechargeable battery and/or power charging assembly) to power off an intelligent umbrella and/or shading system 100 and/or to power off and/or deactivate components and/or assemblies susceptible to lightning strikes and large voltage and/or current surges associated therewith. Advantages of having a lightning sensor integrated within an intelligent umbrella and/or shading system 100 and/or attached, connected or coupled thereto, are that a lightning sensor may identify dangerous conditions, shut down portions of an intelligent umbrella and/or shading system and warn users of a potentially damaging and dangerous situation when a user or operator may not be aware such dangerous conditions are present.

In embodiments, a modular umbrella shading system 100 may comprise an interference sensor (e.g., a noise sensor and/or a wireless noise or interference sensor or scanner). In embodiments, such an interference sensor may identify sources and strengths of noise and/or interference in a vicinity of an intelligent umbrella and/or robotic shading system 100. For example, interference and/or noise may be radio frequency interference, electromagnetic interference, randomly generated noise, impulse noise, acoustic noise, thermal noise, etc. For example, noise and/or interference may be present in certain wireless communication spectrum bands. In embodiments, an interference sensor may be installed or located on a base assembly 110. In embodiments, an interference sensor may be installed or located on a core module or core assembly 130. In embodiments, an interference sensor may be installed or located on a sensor and/or expansion assembly or module 160. In embodiments, an interference sensor may be installed, position, attached, and/or connected to a shading fabric, an arm support assembly and/or an arm or blade of an intelligent umbrella. In embodiments, an interference sensor may be installed on and/or within a sensor housing 168. In embodiments, a lightning sensor may be installed on and/or connected, adhered or coupled to a skin of an intelligent umbrella and/or shading system. In embodiments, an interference sensor may detect noise and/or interference conditions around or in a vicinity of an intelligent umbrella and/or shading system. In embodiments, an interference sensor may detect and/or measure an interference signal strength (e.g., interference that may impact operations of wireless transceivers) and/or an interference type that corresponds to noise sources generating noise and interference in an environment or that is projected and/or communicated into an area around an intelligent umbrella and/or shading system. In embodiments, the noise and/or interference may be from natural sources (e.g., electromagnetic waves, sound waves, impulse waves), from mechanical devices, from acoustic devices, and/or other electronic devices (e.g., home security systems, other routers, wireless printers, wireless transmitters and/or receivers, and/or ICs). In embodiments, an interference sensor may have tolerance conditions established and may identify different type of noise and/or interference. In embodiments, an interference sensor may also able to measure and/or calculate a type of noise and/or interference, where a source may be located and how often the noise and/or interference may be detected and/or measured. In embodiments, an interference sensor may calculate signal measurements, signal strengths, and/or other conditions (e.g., is it repetitive and/or randomly occurring and is it based at least on other conditions associated with measured interference). In embodiments, an interference sensor may communicate signal measurements, signal strengths, other conditions and/or locations to a memory for storage. In embodiments, interference sensor signal measurements, strengths, conditions and/or distances may be communicated to a computing device 136 where one or more processors may execute computer-readable instructions to 1) receive interference sensor signal measurements, strength measurements, and/or conditions; and/or 2) process such measurements and/or conditions. In embodiments, one or more processors (e.g., in a computing device 136) in conjunction with computer-readable instructions executed by the one or more processors may generate commands, instructions, messages and/or signals to cause actions by other components and/or assemblies in response to measurements and/or conditions captured and/or received by an interference sensor. In embodiments, computer-readable instructions fetched from one or more memory modules and executed by a processor (e.g., of a computing device 136) may generate and communicate commands to a motion control board 134 (or other circuits or circuit assemblies) to cause different motor assemblies to move assemblies of an intelligent umbrella and/or shading system to different locations and/or positions. In embodiments, interference sensor measurements may identify that cellular communications may not be reliable in an area around an intelligent umbrella because of a high level of interference in a cellular communications frequency band and computer-readable instructions executable by one or more processors may communicate commands and/or signals to a cellular transceiver to deactivate a cellular transceiver 195. In embodiments, computer-readable instructions executable by a processor may also not communicate any commands, signals, instructions and/or messages to a cellular transceiver 195 until interference and/or noise conditions have improved. In embodiments, computer-readable instructions executed by a processor of a computing device 136 (or other processor/controller) may generate and communicate commands, messages, signals and/or instructions to a sound reproduction system (e.g., an audio receiver and/or speaker) to cause an alarm to be activated and/or a warning message to be reproduced and/or generate and communicate commands, messages, signals and/or instructions to a lighting system and/or sound communication system to generate lights and/or audible alerts indicating a dangerous or problematic situation is occurring or going to occur (e.g., high level of impulse noise or EMI). In addition, because high levels of different types of noise can impact performance of specific electrical components, an interference sensor's measurements, conditions and/or distances may be communicated to a processor and computer-readable instructions executed by one or more processors may generate and communicate commands to a power subsystem (e.g., a rechargeable battery and/or power charging assembly) to power to power off and/or deactivate components and/or assemblies susceptible to noise and/or interference. Advantages of having an interference sensor integrated within an intelligent umbrella and/or shading system 100 and/or attached, connected or coupled thereto, are that an interference sensor may identify problematic conditions, shut down portions of an intelligent umbrella and/or shading system in response thereto, and/or warn users of a potentially problematic and dangerous situation. In addition, an intelligent umbrella with an interference sensor may operate more efficiently by avoiding certain communication frequency bands having large levels of noise which could impact accuracy of wireless communications.

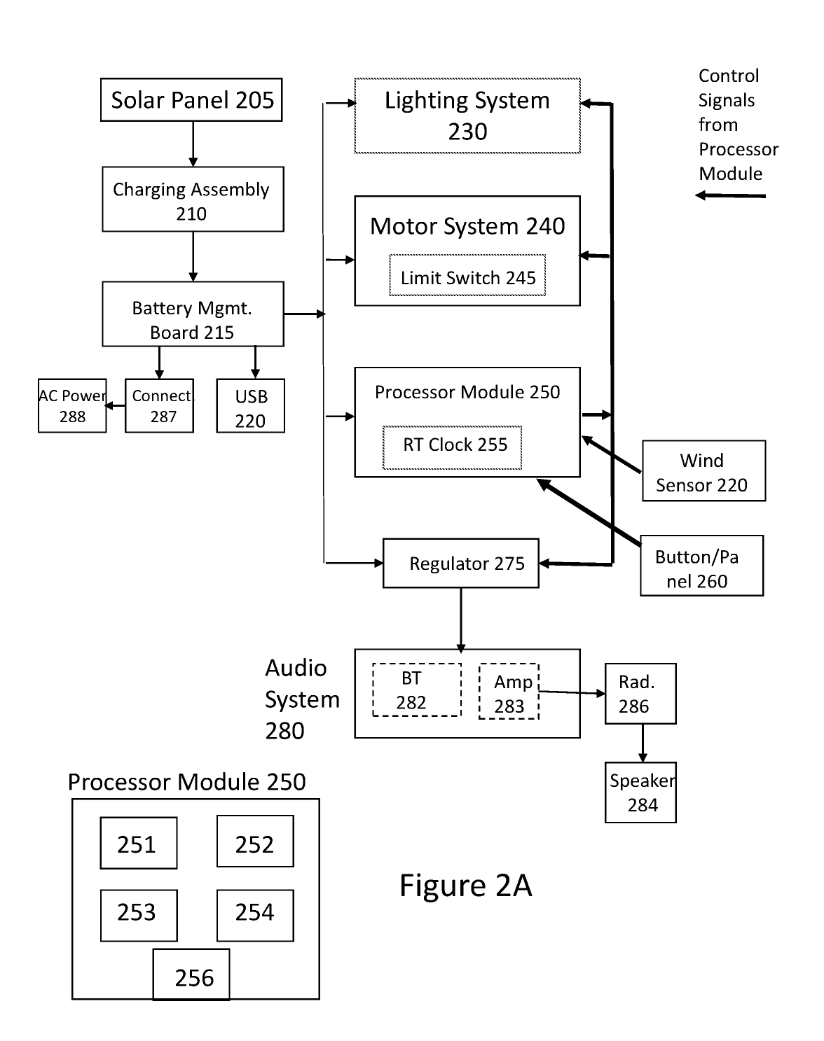

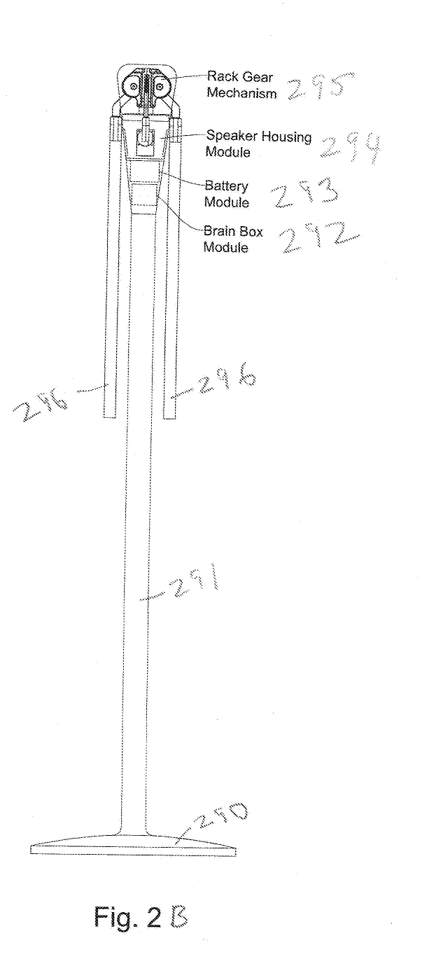

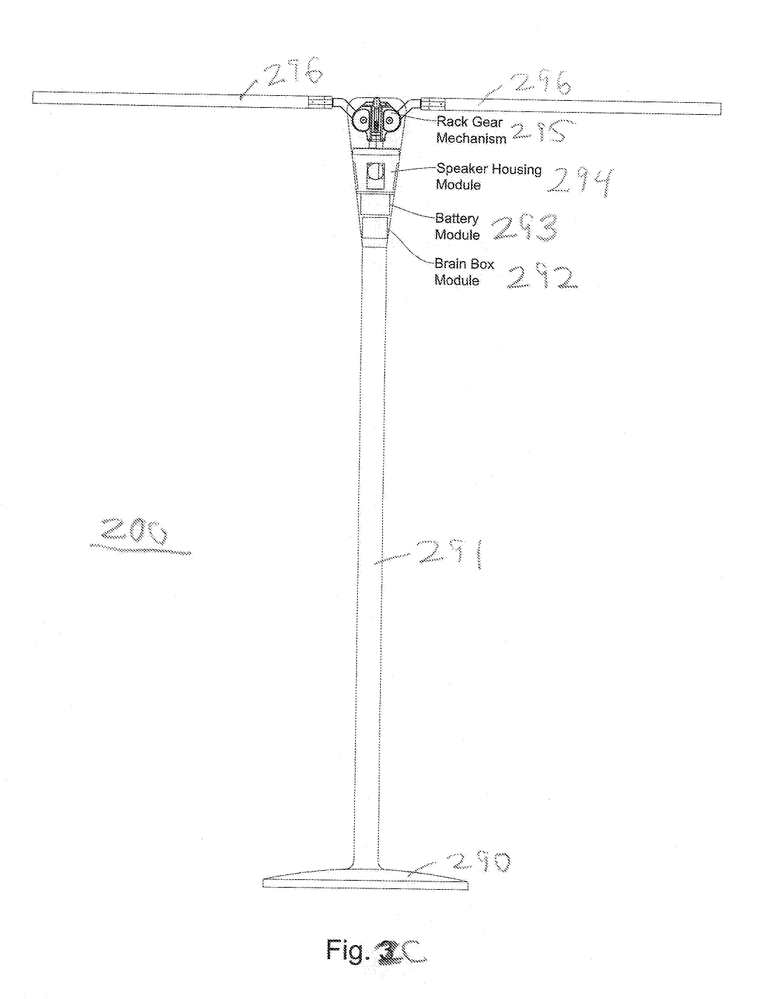

FIG. 2A illustrates a block diagram of an intelligent shading device according to embodiments. In embodiments, an intelligent shading device 200 may comprise one or more solar panel arrays 205, one or more solar power chargers 210, one or more battery management assembly 215 and/or one or more USB connectors 220. In embodiments, one or more solar panel arrays 205 may convert solar energy into high voltage DC power. In embodiments, the one or more solar power chargers 210 may be coupled to the one or more solar power chargers 210. In embodiments, the one or more solar power chargers 210 may be a maximum power point tracker (MPPT) may be an electronic DC to DC converter that optimizes an interface and/or connection between one or more solar panel arrays 205 (e.g., PV panels), and a battery management assembly 215 (including a battery bank). In embodiments, one or more solar power chargers 210 may convert a higher voltage DC output from one or more solar panel arrays 205 down to a lower voltage needed to charge one or more batteries in a battery management assembly 215. In embodiments, one or more batteries in a battery management assembly 215 may be rechargeable batteries and may be LiPo batteries. In embodiments, a battery management assembly 215 may also include a battery holder and/or battery management circuitry (e.g., a printed circuit board, integrated circuits, etc.) to manage the power transfer and/or distribution from the one or more solar power chargers 210 to the batteries in the battery management assembly 215. In embodiments, a battery holder may comprise 1 to 4 holders that each include up to 4 rechargeable batteries. In embodiments, a battery management assembly 215 may be coupled and/or connector to a USB connector 220. In embodiments, a battery management assembly 215 may convert the DC power to a voltage level utilized by the USB connector 220.

In embodiments, a shading device 200 may comprise one or more processor or microcontroller assemblies 250. In embodiments, the one or more processors or microcontroller assemblies 250 may comprise a system on a chip, where the system on a chip may comprise one or more processors or microcontrollers, one or more memory devices, and/or computer-readable instructions executable by the one or more processors to perform certain actions. In embodiments, the one or more processor or microcontroller assemblies 250 may comprise one or more microprocessors or controllers 254. In embodiments, the one or more microprocessors or controllers 254 may be an ARM microprocessor, an AMD microprocessor and/or an Intel microprocessor. In embodiments, the one or more processor or microcontroller assemblies 250 may comprise a low-power PAN transceiver 251 (e.g., a low power Bluetooth transceiver) and/or a wireless local area network transceiver 252 (e.g., a WiFi transceiver for example at 1.2 and/or 2.4 Gigahertz WiFi transceiver). In embodiments, the one or more processor or microcontroller assemblies 250 also may include a Controller Area Network (CAN) controller 253 (which may also be an ANT controller). In embodiments, the one or more processor or microcontroller assemblies 250 may comprise one or more cellular transceivers 256 (e.g., one or more 2G, 3G or 4G cellular transceivers). In embodiments, the one or more processor or microcontroller assemblies 250 may utilize a CAN bus and/or ANT bus to communicate with devices within the assemblies 250 and/or with other devices, assemblies and/or components in the shading device 200. In embodiments, the one or more processor or microcontroller assemblies 250 may also comprise a clock device 255. In embodiments, the clock device 255 may comprise a real time clock. In embodiments, the clock device 255 may not be installed or be resident on the one or more processor or microcontroller assemblies 250. In embodiments, the one or more processor or microcontroller assembly 250 may be a Libre system-on-chip processor. In embodiments, the one or more processor or microcontroller assembly 250 may be a Nordic Semiconductor NRF42832 system-on-a-chip.

In embodiments, the computer-readable instructions may be executable by one or more processors 254 in the one or more processor or microcontroller assemblies 250 to communicate with the one or more motor systems or subassemblies 240, the one or more lighting systems or assemblies 230 and/or the one or more audio systems 280. In embodiments, a mobile computing device (e.g., mobile phone, tablet, wearable computing device, etc.) may communicate instructions, commands and/or messages with the one or more processors 254 utilizing the one or more low-power PAN transceiver 251, the and/or the one or more wireless LAN (or WiFi) transceivers 252, the one or more ANT or CAN controllers 253 and/or the one or more cellular transceivers 256, which are then communicated to the other components, assemblies and/or devices in the shading device 200.

In embodiments, one or more buttons 260 may be pressed and/or activated which may send a signal and/or command to the one or more processor or microcontroller assembly 250 to have the shading device 200 perform certain actions (such as activating and/or deactivating certain components and/or assemblies (e.g., one or more lighting systems or assemblies 230 and/or one or more motor systems and/or assemblies 240). In embodiments, one or more buttons 260 may communicate commands or messages to activate or deactivate one or more of the PAN transceiver 251, the WiFi transceiver 252, the microprocessor or controller 254, the one or more cellular transceivers 256, and/or the memory devices (e.g., to take the shading device out of a sleep state). In embodiments, only certain components or transceivers may be activated.

In embodiments, one or more wind sensors 270 may monitor wind speed in an environment surrounding the shading device 200. In embodiments, the one or more wind sensors 270 may communicate a wind speed measurement to the one or more processor or microcontroller assemblies 250. In embodiments, the computer-readable instructions executable by one or more processors 254 in the processor or microcontroller assembly 250 may receive the wind speed measurement, compare the received wind speed measurement to a threshold value, and if the received wind speed measurement is over the threshold value, communicate instructions, messages, commands and/or signals to the motor system 240 to cause the motor system to retract the arm or blade assemblies from an open position to a storage or retracted position. In embodiments, this protects a shading device 200 from potentially tipping over due to high winds. In embodiments, the one or more wind sensors 270 may include computer-readable instructions and/or a processor (or similar circuitry) to determine whether or not the captured wind speed measurement is greater than a threshold measurement. If the one or more wind sensors (along the processor and computer-readable instructions (or circuitry) determines the captured wind speed measurement is greater than the threshold value, the one or more wind sensors 270 may communicate a signal, command, message or instruction to the one or more processors 254, via a bus. In response, computer-readable instructions executable by the one or more processors 254 may communicate instructions, messages, commands and/or signals to the motor system 240 to cause the motor system 240 to retract the arm or blade assemblies to a closed position.

In embodiments, one or more motor systems 240 may be utilized to retract and/or open one or more arms or blades (and/or a frame system) along with associated shading fabric to provide shade or protection to users, operators and/or devices being protected by the shading device 200. In embodiments, the one or more motor systems 240 may include a rack gear assembly, which may be described in detail later, a cable and rope assembly and/or a threaded rod or bolt to expand and/or retract the arms, blades or frame. In the embodiment illustrated in FIG. 2A, the shading device 200 may only comprise one motor system 140 to open and/or close the arms, blades or frame of the shading device. In embodiments, the one or more motor systems 240 may comprise one or more limit switches 245. In embodiments, the one or more limit switches 245 may prevent motors in the one or more motor systems 240 from rotating at too high of a speed or from generating too much torque.

In embodiments, the shading device 200 may comprise one or more lighting systems or assemblies 230. In embodiments, the one or more processors and/or microcontrollers 254 may communicate instructions, commands, signals and/or messages via a bus (e.g., a CAN bus) to the one or more lighting systems or assemblies 230 to activate and/or deactivate the lighting assemblies 230. In embodiments, the one or more lighting assemblies 230 may be dimmable or may have adjustable settings. In embodiments, the one or more lighting assemblies 230 may be synchronized to music being played or reproduced via the audio system 280. In embodiments, the instructions, commands, signals or messages that request or control lighting system synchronization with audio being played or that request dimming or adjusting of the lighting assemblies 230 may be communicated from the one or more processors 250 in the one or more microprocessor or microcontroller assemblies 250. In embodiments, the one or more lighting assemblies 230 may comprises a lighting controller and/or one or more lighting elements. In embodiments, the one or more lighting elements 230 may be LED light bulbs, fluorescent light bulbs or filament-based light bulbs. In embodiments, the one or more lighting assemblies 230 may be integrated into the one or more arms or blades of the shading device.

In embodiments, an audio system 280 may comprise an additional PAN transceiver 282, one or more amplifiers 283 and/or one or more speaker assemblies 284. In embodiments, the additional PAN transceiver 282 may be a BlueTooth transceiver, a Zigbee transceiver and/or other PAN transceiver. By having an additional PAN transceiver 282 additional direct communications may be communicated to the audio system 280 without passing through one or more processors or transceivers in the microcontroller assembly 250. In other words, the PAN transceiver in the microcontroller assembly 250 may not be utilized. This may allow faster playing and/or streaming of music to the audio system 280 in the shading device 200. This is an improvement as compared to how other umbrellas may communicate audio files to an umbrella. In embodiments, the use of a PAN transceiver 252 in the one or more processor or microcontroller assemblies 250 may allow communication to another assembly, component or device (e.g., motor assembly 240 or lighting assembly 230 within the shading device while there is communication of or streaming of audio files through the PAN transceiver 282 in the audio system or assembly 280. In embodiments, this may allow for more efficient and quicker operation of a shading device 200. In embodiments, streamed and/or downloaded audio files may be communicated through the additional PAN transceiver 282 to the one or more amplifiers 283 and then to the one or more audio speakers 284. In embodiments, a radiator 286 may enhance sound quality and the radiator 286 may be placed between the one or more amplifiers 283 and the one or more audio speakers 284.

In embodiments, power (e.g., voltage and/or current) may be supplied to different components and/or assemblies of the shading device 200. In embodiments, different DC voltages may need to be supplied to different components, devices and/or assemblies of the shading device. In embodiments, some components, devices or assemblies may utilize 12 to 14 Volts DC as an input voltage, whereas other components, device or assemblies may utilize 3.3 to 5 volts DC as an input voltage. In embodiments, the battery management assembly 215 may transfer power to devices that require 12 to 14 Volts DC through a power bus that is separate from a CAN bus. In embodiments, the battery management assembly 215 may transfer power to one or more voltage regulators 275 and the one or more voltage regulators 275 may communicate 3.3 to 5 Volts DC, via a power bus, to the components or devices that require these voltages for operation. In embodiments, one or more batteries 215 may need to be recharged by a source separate from a solar panel (due to cloudy weather, storage, malfunction, etc.) In embodiments, a shading device 200 may comprise a connector 287. In embodiments, a cable may connect an AC power source 288 to the connector 287 to provide additional, supplemental or primary power to operate the shading device 100 and/or recharge the battery power source 215. In embodiments, an audio system 180 may comprise one or more passive radiators 286 to improve sound quality. In embodiments, an audio system 280 may also comprise a woofer, subwoofer, tweeter or additional amplifiers or a combination thereof to provide better audio quality to a user.

FIGS. 2B and 2C illustrate a shading device associated with a block diagram of FIG. 2A according to embodiments. In embodiments, FIG. 2B illustrates a shading device in a closed position (e.g., the arms or blades are in a closed or retracted position) according to embodiments. FIG. 2C illustrates a shading device in a deployed position (e.g., the arms or blades are in a deployed or open position). In embodiments, a shading device 200 may comprise a base or base assembly 290, a support assembly 291, a brain box module 292, a battery module 293, a speaker housing module 294 (including at least a battery management board 215), a rack gear assembly or mechanism 294 and/or one or more arms or blades 295. In embodiments, a base or base assembly 290 may be in contact with a surface, such as a floor, a patio, grass, sand and/or other surface materials. In embodiments, a different base or base assembly may be utilized to connect and/or attach to a table, sand, and/or a grass surface. In embodiments, a support assembly 291 may be coupled and/or connected to a base assembly 290. In embodiments, a support assembly 291 may comprise a tube or shaft and a cover assembly (which may also be referred to a skin assembly). In embodiments, a cover assembly may be coupled or connected to a tube and/or shaft. In embodiments, a tube may be comprised or made of a lightweight metal material or a plastic material. In embodiments, portions of a motor assembly and/or wires or cables may be installed and/or housed in an interior of a tube or shaft. In embodiments, other components or assemblies may also be located and/or housed in an interior of a tube or shaft. In embodiments, there may be space or openings between a skin assembly and/or a tube or shaft. In embodiments, this may allow components to be installed in housings or assemblies that are located in an opening or space between a skin or cover assembly and a tube or shaft.

In embodiments, a brain box or electronics module 292 may be connected and/or coupled to a support assembly 291. In embodiments, a brain box or electronics module 292 may house electronics such as one or more processors or controllers, one or more sensors, one or more memory devices, as well as other electronic components. In embodiments, one or more processor or controller assemblies 250 may be located or housed in a brain box. In embodiments, one or more processor or controller assemblies 250 may comprise one or more processors or controllers, one or more memory devices, one or PAN transceivers, one or more cellular transceivers and/or one or more WiFi transceivers, and one or more clock assemblies (e.g., real time clocks). In embodiments, a brain box or electronics module 292 may also comprise a battery management assembly or PCB 215 and one or more USB ports or connectors 220, although these components may be located or housed in other modules or assemblies. In embodiments, a brain box or electronics module 292 may comprise one or more wind sensors 270 and/or one or more operational buttons or control panel 260, although these components may be located or housed in other modules or assemblies. In embodiments, a brain box or electronics module 292 may also comprise portions of a motor assembly 240 (e.g., a motor controller or other components or assemblies) although these components may be located or housed in other modules or assemblies. In embodiments, a brain box or electronics module 292 may also comprise portions of a lighting assembly 230 (e.g., a lighting controller or ballast assembly), although these components may be located or housed in other modules or assemblies. In embodiments, a brain box or electronics module 292 may also comprise one or more voltage regulators 275, although these components or assemblies may be located or housed in other modules or assemblies. In embodiments, a brain box or electronics module 292 may be attached and/or connected to a tube or shaft in the shading device. In embodiments, a brain box or electronics module 292 may be attached and/or connected to a cover housing or a skin assembly. In embodiments, a brain box or electronics module 292 many control and/or manage operations of a shading device (e.g., opening or closing of shading device, activate or deactivate a lighting assembly, and/or activate or deactivate an audio system or play music via the audio system).

In embodiments, a shading device 200 may comprise a battery module 293. In embodiments, a battery module 293 may comprise a plurality of rechargeable batteries. For example, a battery module 293 may comprise between four to twelve rechargeable batteries. In embodiments, a battery module 293 may also comprise or more solar power chargers 210 (e.g., a MPPT). In embodiments, a battery module 293 may also comprise a battery management assembly 215, which may be a printed circuit board including multiple LiPO4 4S2P batteries). In embodiments, one or more solar power chargers 210 (e.g., a MPPT) may convert a higher voltage DC output from one or more solar panel arrays 105 down to a lower voltage needed to charge one or more batteries in a battery management assembly 215. In embodiments, a battery management assembly 215 may also include a battery holder and/or battery management circuitry (e.g., a printed circuit board, integrated circuits, etc.) to manage the power transfer and/or distribution from the one or more solar power chargers 210 to the batteries in the battery management assembly 215. In embodiments, a battery module 293 may reside above an electronics module or brain box module 292. In embodiments, a battery module 293 may be made utilizing additive manufacturing techniques. In embodiments, a battery module 293 may be comprised of a plastic material or a composite material, or a combination thereof. In embodiments, a battery module 293 may be coupled or connected to a tube or a shaft. In embodiments, a battery module 293 may be coupled or connected to a skin or cover assembly. In embodiments, a battery module 293 may be installed or resident in a space between a tube or shaft and or a skin or cover assembly.

In embodiments, a shading device 200 may comprise a speaker housing module 294. In embodiments, a speaker housing module 294 may be made utilizing additive manufacturing techniques. In embodiments, a speaker housing module 294 may be comprised of a plastic, a lightweight metal or a composite material, or a combination thereof. In embodiments, a speaker housing module 294 may comprise one or more speakers 284, one or more personal area network transceivers 282 (e.g., Bluetooth transceivers) or one or more amplifiers 283. In embodiments, a speaker housing module 294 may be installed or positioned above a battery module 293. In embodiments, a speaker housing module 294 may be connected and/or coupled with a tube or shaft of a shading device 200. In embodiments, a speaker housing module 294 may be flush or in line with a skin or cover assembly of a shading device 200. In embodiments, the speaker housing module 294 is integrated within the shading device and is not separate. In embodiments, a skin may cover portions of a speaker housing module. In embodiments, the speaker housing module 294 flows within the design of the shading device and is located between the battery module 293 and/or rack gear mechanism 295. In embodiments, the speaker housing module 294 may include one or more integrated passive radiator assembly.

In embodiments, a shading device 200 may comprise a rack gear assembly 295 and one or more arms or blades 296. FIG. 2B illustrates a shading device having one or more arms or blades 296 in a closed position. FIG. 2B illustrates a shading device having one or more arms or blades 296 in an open or deployed position. In embodiments, a brain box or electronics module 292 may communicate with a motor assembly to operate a rack gear assembly 295, which in turn will move and open or deploy the one or more arms or blades 296 in order to provide shade to users or operators of the shading device 200. In embodiments, one or more rack gear assemblies 295 and one or more arms or blades 296 may be made or created utilizing additive manufacturing techniques. In embodiments, one or more rack gear assemblies 295 and one or more arms or blades 296 may be made of a plastic material, a lightweight metal or a composite material, or a combination thereof. In embodiments, the one or more rack gear assemblies 295 or the one or more arms or blades 296 are described below.

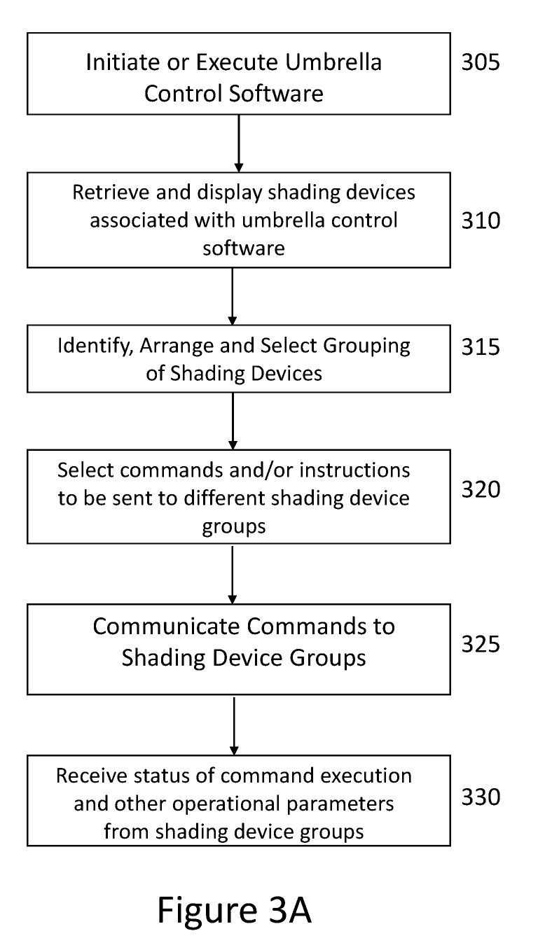

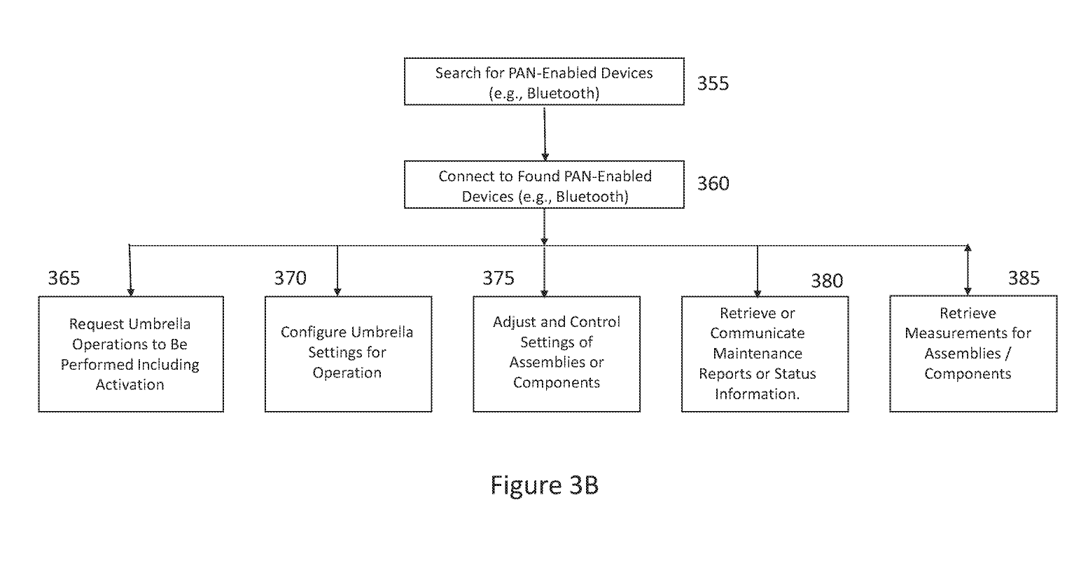

FIG. 3A illustrates a flowchart outlining a process for controlling a shading device according to embodiments. Embodiments described herein are meant to be illustrative examples rather than be limiting with respect to claimed subject matter. Likewise, an embodiment may be simplified to illustrate aspects and/or features in a manner that is intended to not confuse and/or hide claimed subject matter through specificity and/or details. Embodiments in accordance with claimed subject matter may include all of, less than all, or more than blocks 305-342. In embodiments, the order of blocks 305-342 may merely be an illustrative order and other orders may be possible.

In embodiments, computer-readable instructions executable by one or more processors or microcontrollers may perform the process described below. In embodiments, the computer-readable instructions may be executable by one or more processors on a mobile computing device (e.g., a smartphone, a tablet, a wearable computing device), a server computing device, a desktop computing device, a laptop computing device, or a combination thereof. In embodiments, in other words, the application software may be resident on a mobile computing device, a server computing device, a desktop computing device, or a combination thereof. In embodiments, a graphical user interface or menu may be presented on a monitor or screen of one of the computing devices discussed above, to allow a user or operator to select items to be executed or steps to be executed. In embodiments, a computing device or even a shading device may comprise voice recognition software to allow a user or operator to select actions and/or options to be performed via voice commands. In embodiments, the software application may be referred to as fleet management software in a Smartshade software application.

Initially, in step 305, a shading product or shading product group may be selected to communicate with. In embodiments, such as hotels, restaurants, outdoor concerts, office buildings, etc., a fleet of shading devices may be controlled via one or more computing devices. In embodiments, for example, a user or operator (or hospitality manager) may select to communicate with single axis parasols (e.g., expansion only parasols) in a specific geographic area such as by a pool. In embodiments, a user and/or operator may utilize the software application (e.g., SMARTSHADE software) to set up shading products type (e.g., BLOOM parasols, SUNFLOWER umbrellas, etc.) and/or shading product groups (e.g., based on geography or location) that the user or operator may communicate commands or instructions to.

In embodiments, in step 310, once a shading product type or a shading product group is selected, one or more specific shading devices may be selected from a list of shading devices that are displayed through the software application. In embodiments, a single shading device may be selected. In other embodiments, multiple shading devices may be selected and the same actions may be performed on all of the selected shading devices. Alternatively, in other embodiments, multiple shading devices may selected and the software application may include a split screen, where different options and/or actions may be selected.

In embodiments, in step 315, the computer-readable instructions executable by one or more processors of the one or more computing devices may display options available for the one or more shading devices. In embodiments, the options and/or actions may be displayed as icons, menu items, universal symbols and/or alphanumeric texts. In embodiments, the options may include, but are not limited to: 1) settings or setup menu; 2) motor activation/deactivation; 3) sensor monitoring or activation/deactivation; 4) lighting activation/deactivation or adjusting; 5) automatic operation activation/deactivation; and/or 6) audio system activation/deactivation and/or setting of music. In other embodiments, other options may include, but are not limited to: 1) video activation/deactivation, storage and/or streaming; 2) addition sensor monitoring and/or activation/deactivation; 3) music and/or lighting system synchronization; 4) wireless transceiver selection and/or activation deactivation; and/or 5) proximity sensor/motion detector monitoring and/or activation/deactivation.

In embodiments, in step 320, a user or operator may select control options and/or actions for the selected shading device. In embodiments, as discussed above, the options and/or actions may be selected by touchscreen interaction, pressing mechanical/electromechanical buttons, voice commands, cursor selection and/or gesture-based selection. In embodiments, in response to selection of control options and/or actions one of a plurality of menus or input screens may be displayed on the computing device.

In embodiments, in step 321, a user or operator may select a settings or threshold menu in order to establish measurements for different assemblies or components and/or different times for activation of assemblies and/or components. In embodiments, for example, in step 342, a user or operator may select to establish or set when a shading device may be operated in an automatic mode. In embodiments, a user or operator may select a time and date at which to initiate automatic operation (e.g., 4:00 pm EST or 8:00 am PST), minutes until the shading device may initiate automatic operation (e.g., in 10 minutes or 2 hours), or under what conditions a shading device may initiate automatic operation (e.g., wind speed low, temperature reading in a specific range, and/or time of day). In embodiments, the entered or received time, date, time period and/or environmental conditions may be stored in one or more memory devices of a computing device (e.g., mobile computing device, server computing device, wearable computing device and/or desktop computing device) and/or a memory device of the shading device.

In embodiments, in step 340, a user or operator may be able to select a wind speed (or other environmental sensor measurement at which to retract arms or blades of a shading device and/or possibly deactivate certain components of a shading device. In embodiments, for example, a user or operator may select that if a wind speed sensor is above 25 miles per hour, a shading device should be closed. In embodiments, for example, a user or operator may select that if a humidity sensor reading or air quality sensor readings are greater than specified input values, the shading device may be deactivated or closed and/or certain components may be deactivated (e.g., wireless transceivers and/or lighting assemblies).

In embodiments, in step 332, a user or operator may select to open or close the blades or arms of the shading device by communicating with one or more motor assemblies. In embodiments, a motor assembly may be an expansion motor assembly. In embodiments, the computer-readable instructions executed by the processor of the computing device (e.g., mobile computing device, tablet computing device, wearable computing device, server computing device, desktop computing device or a combination thereof) may present a user with three options: open, close or stop. These options may be presented audibly, as icons, as text or as a combination thereof. In embodiments, when the computer-readable instructions executed by the processor of the computing device receive the selection, a command, instruction or signal is communicated to an expansion motor assembly to perform the requested action. In embodiments, other motors (e.g., azimuth rotation motors and/or elevation rotation motors) may also be activated, deactivated and/or stopped utilizing similar techniques to those discussed above if a shading device has more than three rotations of axis (and thus may have three motor assemblies).

In embodiments, in step 333, a user or operator may select to activate or deactivate the lighting assembly by communicating with the one or more lighting assemblies. In embodiments, a user or operator may adjust a lighting intensity of the one or more lighting assemblies according to embodiments. In embodiment, the computer-readable instructions executed by the one or more processors of the computing device, may present a user with a lighting icon and/or a lighting adjustment indicator (e.g., such as a slide ranging from completely off to high intensity). In embodiments, these options may be presented audibly, as icons or as text or as a combination thereof. In embodiments, these options and/or actions may be selected via voice commands, touchscreen inputs, keystrokes or gestures or a combination thereof. In embodiments, when the computer-readable instructions executable by the processor receive the lighting option or action, a command, instruction or signal is communicated to the one or more lighting assemblies to activate, deactivate and/or adjust an intensity of the lighting assembly.

In embodiments, in step 334, a user or operator of a shading device may select music to be played on an audio system of the shading device. In embodiments, the computer-readable instructions executed by the one or more processors of the computing device may present the user with one or more available music library (or music app) software programs for a user or operator to identify and select. In embodiments, these options may be presented as icons, as text or audibly, or a combination thereof to a user or operator. In embodiments, the different music app options may be selected via voice commands, touchscreen inputs, keystrokes or gestures or a combination thereof. In embodiments, for example, available music apps may be iTunes, Spotify, Pandora, Amazon Music as well as others. In embodiments, when the computer-readable instructions executable by the one or more processors receive the music app selection command, a PAN transceiver (e.g., a Bluetooth transceiver) may communicate with an additional PAN transceiver (e.g., located in an audio system of the shading device) to begin downloading and/or streaming the audio or music files to the audio system of the shading device, where the audio files may be communicated to one or more amplifiers and further to one or more speakers to play the music for the user or operator.

In embodiments, in step 335, automatic operation mode may automatically occur based upon settings that were previously setup. In embodiments, an automatic operation mode may occur at a pre-established initiation time and a shading device may open arms and/or blades. In embodiments, a shading device and its arms and/or blades may close at a pre-established closing time.

In embodiments, in step 336, a user or operator may monitor wind speed of an area around a shading device via a wind sensor. In embodiments, the computer-readable instructions executed by the one or more processors of the computing device may communicate with one or more wind sensors (and/or other sensors) and receive a sensor measurement from the one or more wind sensors. In embodiments, the one or more computer-readable instructions executable by the one or more processors of the computing device may present a user or operator with the wind speed in a display area on the monitor of the computing device. In embodiments, the wind speed measurement may be presented audibly, visually or via text or a combination thereof. In embodiments, the computer-readable instructions executable by the one or more processors of the computing device may present a current wind speed measurement and/or a sliding scale for a wind speed sensor sensitivity. In embodiments, a user or operator may select a low or high sensitivity which is a value at which a shading device may close or retract its arms or blades in order to safely maintain operation. In embodiments, a user or operator may also select a timeframe at which shading device may deploy after an acceptable wind speed measurement is received. (e.g., 2 or 3 minutes or 15 minutes). In embodiments, if the computer-readable instructions executable by the one or more processors of the computing device receive a wind speed measurement value above the preset threshold value, a command, instruction and/or message may be communicated to the one or more motor assemblies to close and/or retract the arms or blades of the shading device (and potentially turn off the shading device if the conditions are especially dangerous). While the discussion above relates to wind sensors (the discussion also applies to other environmental sensors measuring potentially dangerous conditions, (e.g., humidity sensors, temperature sensors, air quality sensors, ultraviolet sensors, carbon monoxide or carbon dioxide sensors).

FIG. 3B illustrates a mobile communications device (or other computing device) communicating with a plurality of shading devices according to embodiments. In embodiments, a mobile communications device (or other computing device) may be able to communicate with and/or receive communications from one or more shading devices, as discussed above. In other words there is bidirectional communications, unlike with other prior existing shading devices and specifically remote control, where there is only one way communication. In embodiments, in order to initiate communications between a mobile communications device (or other computing device) and more than one shading devices, a mobile communications device (or other computing device) may search 355 for other personal area network (PAN)-enabled shading devices. In embodiments, the PAN protocol may be Bluetooth, Bluetooth Low-Energy (BLE) or Zigbee. Although FIG. 3B is described with respect to Bluetooth (or PAN) wireless protocol, the below discussion may also be implemented utilizing 802.11, WiFi and/or cellular wireless communication protocols. In embodiments, the mobile communications device (or other computing device) may connect 360 to found or established PAN-enabled shading devices. In embodiments, for example, the BLE transceiver of the mobile communications device (or other computing device) may connect with four shading devices, which each have a BLE transceiver. In embodiments, for example, the WiFi transceiver of a mobile communications device may connect to six shading devices, each which have a WiFi or other 802.11 transceiver.

In embodiments, the mobile communications device (or other computing device) may perform a number of actions with and/or receive data from a plurality of shading devices. In embodiments, the mobile communications device (or other computing device) may request 365 that one or more umbrella operations be performed including but not limited to activation of one or more components and/or assemblies of the one or more shading devices.

In embodiments, the mobile communications device (or other computing device) may transmit commands, instructions, parameters and/or measurements to configure 370 settings of components and/or assemblies of the one or more shading devices. In embodiments, the settings may include threshold temperature, humidity, or air quality readings and/or an initial resolution for a camera to capture image. In embodiments, the settings may include which initial light intensity values and/or initial sound system volume values.

In embodiments, the mobile communications device (or other computing device) may transmit commands, instructions, parameters and/or measurements to adjust and/or control 375 settings of assemblies and/or components in the one or more shading devices. In embodiments, these settings may be a rotation of a support assembly with respect to a base assembly. In embodiments, these settings may be an elevation angle of an upper support assembly with respect to a lower support assembly or these settings may be whether the arm expansion assembly (or rack gear assembly) is in a closed and/or open position.

In embodiments, the mobile communications device (or other computing device) may retrieve, access, request and receive 380 status messages or parameters and/or maintenance reports from the one or more shading devices. In embodiments, for example, the status messages or parameters or maintenance reports may include status of the one or more motor assemblies or controllers in the shading devices and/or the status of any of the environment sensors or directional sensors present in the one or more shading devices. In embodiments, for example, the maintenance reports and/or status messages or parameters may include reports retrieved from an integrated computing device within one or more shading devices, which may have been storing data or information in one or more memory devices.

In embodiments, the mobile communications device (or other computing device) may also retrieve and/or receive 385 measurements and/or parameters from components and/or assemblies in the one or more shading devices. In embodiments, for example, the mobile communications device (or other computing device) may receive measurements from the one or more sensors including temperature readings, wind readings, humidity readings, air quality readings, latitude and/or longitude readings. In embodiments, for example, the mobile communications device (or other computing device) may receive measurements from the solar power charging assembly and/or solar panels with respect to power generated and/or power utilized. In embodiments, for example, the mobile communications device (or other computing device) may receive video and/or images from the cameras in the one or more shading devices.

Below described is possible potential communications between mobile communication device (or other computing device) and/or a plurality of shading devices. In embodiments, an important feature of the shading devices of Shadecraft is an ability for a mobile computing device to communicate with, control and/or receive data, information, parameters or measurements from the two or more shading devices. In embodiments, the utilization of Bluetooth Low Energy (BLE) allows for reduction in power consumption by the umbrellas. This is important for solar powered umbrellas where there may be a limited amount of power available. In embodiments, a mobile communications device (or other computing device) may communicate with multiple shading devices. In embodiments, the mobile communications device may control operations of the multiple shading devices. In embodiments, the mobile communications device may receive data, information, parameters and/or measurements from the multiple shading devices. In embodiments, in order to conserve energy, many of the communications between the mobile communication device (or other computing device) and the

In embodiments, a Generic Attribute Protocol (GATT) may be utilized for communications between a mobile communications device and the one or more shading devices. In embodiments, a mobile communications device (or a computing device) may be a GATT server or control device and the multiple shading devices may be GATT client devices. In embodiments, a GATT client (shading device) may communicate with one GATT server device (e.g., mobile communication device) during a session and may be thus be only utilizing power for that communication. If the GATT protocol is utilized, whereas the GATT server device may be communicating with a number of GATT client devices at one time, the GATT client device (shading device) may only communicate with one GATT server device (mobile communication device or computing device) at a time. In embodiments, other protocols may also be utilized to allow the shading devices to have alternative communication paths.

In embodiments, the mobile communications device may be able to control and/or then observe and receive status of shading device activities. In embodiments, then the mobile communications device may receive performance measurements and/or parameters, audio and/or video, and/or environmental or directional parameters, measurements and/or information from the shading device and display such within the shading device application software on the mobile communication device. In embodiments, the activities of the multiple shading devices that may be controlled may be: 1) the expanding or opening and the closing of the arms or blades of the shading device; 2) the rotating of the shading device about an azimuth axis and/or about a base assembly; and/or the 3) the tilting of a portion of the shading device with respect to another portion of the shading device (e.g., changing in an elevation such as rotating an upper portion of the support assembly with respect to a lower portion of the support assembly). In embodiments, the activities of the multiple shading devices that may be controlled may be a calibration of a direction of the shading device; setting of a date and/or time for the shading device; setting sun rise time for automatic operation (e.g., opening or adjusting a shading device); setting sun set time for automatic operation (e.g., closing or adjusting a shading device for sunset); setting up and/or selecting a wireless transceiver (e.g., cellular, WiFi or personal area network-Bluetooth or BLE); and/or update weather conditions or settings for the shading device (e.g., wind sensor sensitivity, temperature and/or humidity sensitivities). In embodiments, the activities of the multiple shading devices that may be controlled may also include: 1) adjusting an intensity of a lighting assembly; 2) pausing and/or playing music or digital music files; 3) controlling volume settings for reproducing sounds; 4) turning on and/or off the camera and/or adjusting camera settings; and/or 5) adjusting a wind sensor sensitivity.

In embodiments, the multiple shading devices (or each shading device) may communicate some of the following parameters, measurements and/or information to the mobile communication device (or other computing device). In embodiments, the parameters, measurements, and/or information may be 1) open and/or close status; 2) directional parameters, measurements and/or information; 3) angular parameters, measurements and/or information; 4) GPS location parameters, measurement and/or information; 5) obstacle detection parameters, measurements, and/or information; 6) presence or motion detection parameters, measurements, and/or information; 7) battery health, percentage left or expended, and/or battery temperature; and/or 8) performance of solar panels and/or solar charging assembly. In embodiments, the parameters, measurements and/or information may also be 1) environmental conditions (e.g., temperature readings, humidity readings, air quality readings, carbon monoxide readings, carbon dioxide readings); 2) wind speed measurement, parameters and/or information; 3) ambient light measurements, parameters, and/or information; 4) ultraviolet sensor measurements, parameters and/or information; 5) rain sensor parameters, measurements, and/or information; and/or 6) lightning sensor parameters, measurements, and/or information.

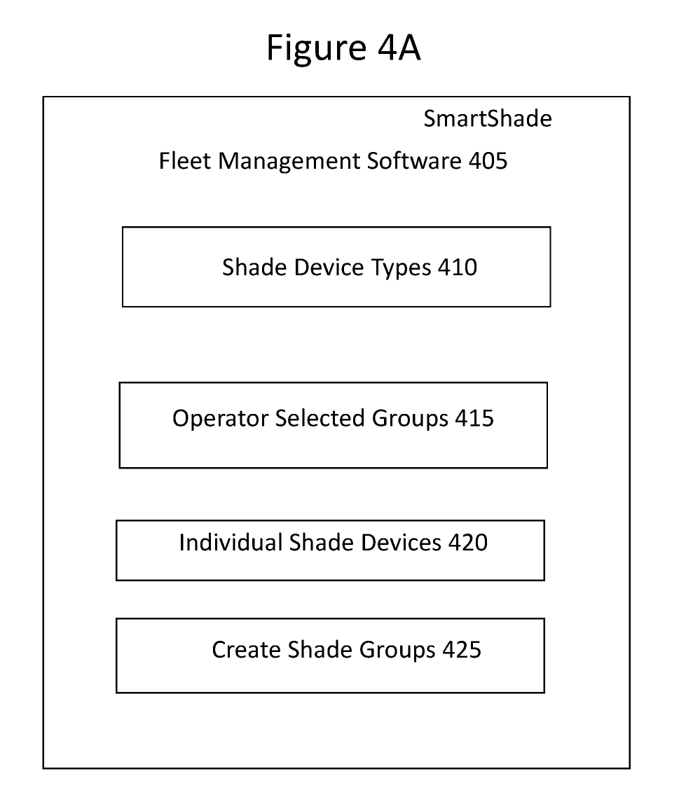

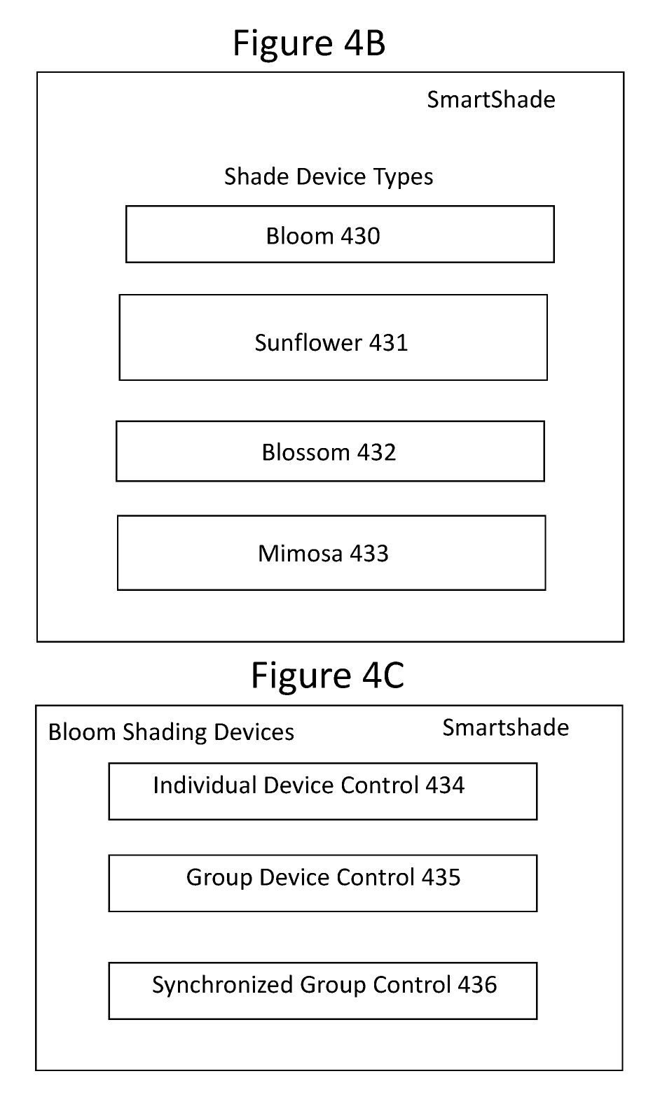

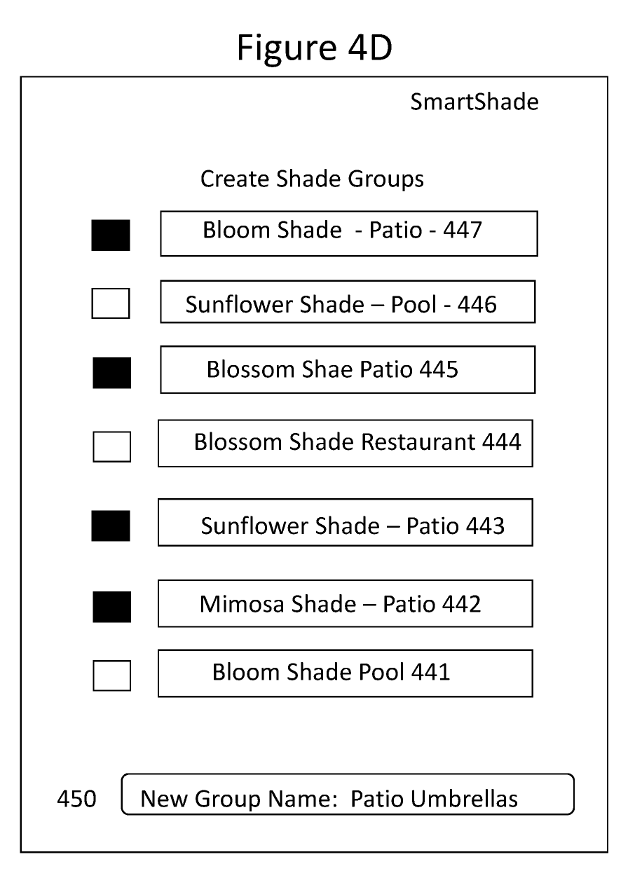

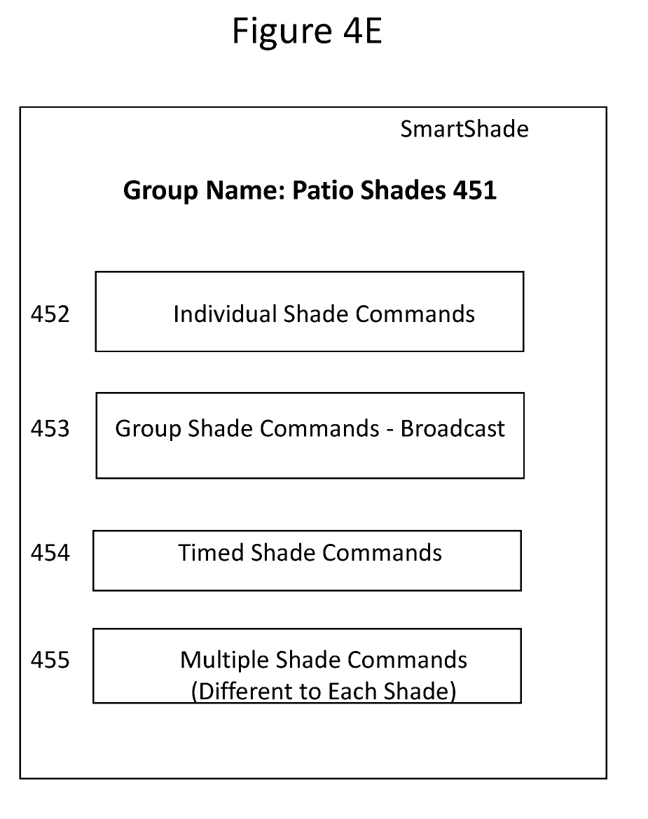

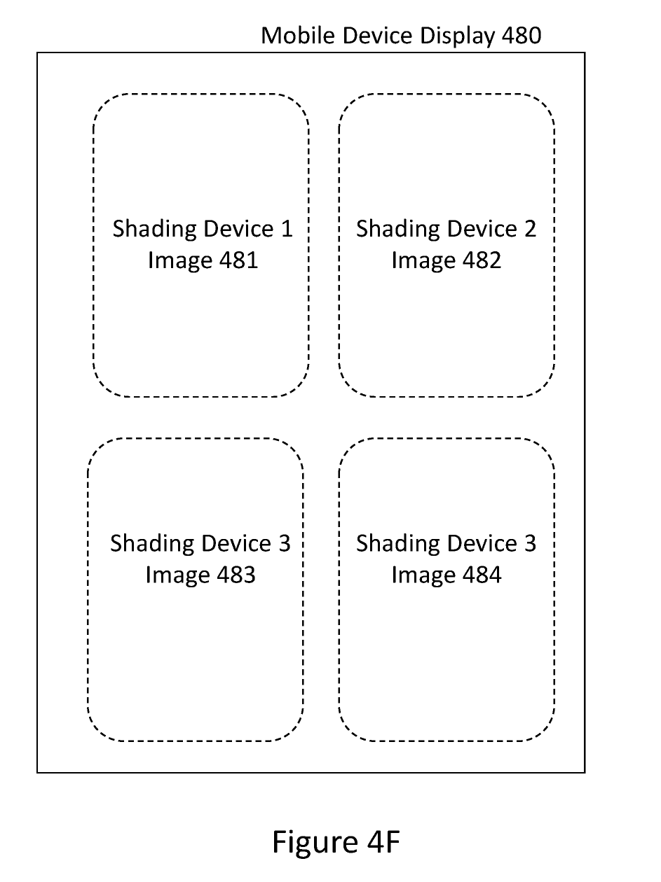

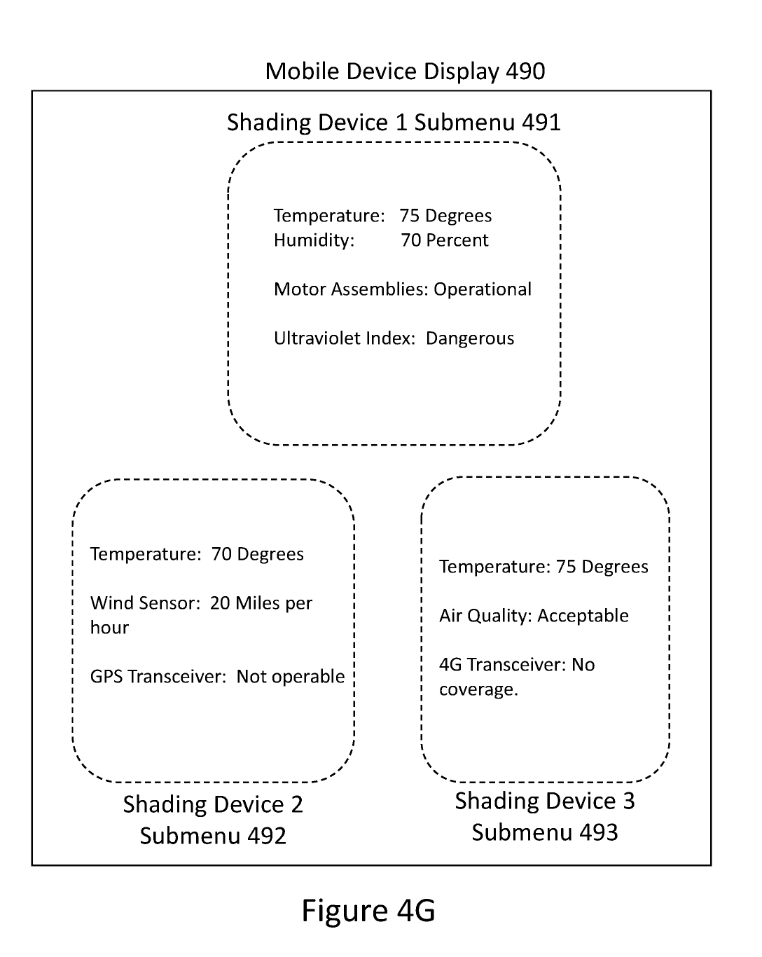

FIG. 4A illustrates fleet management system operation according to embodiments. In embodiments, a mobile computing device may comprise one or more processors, one or more memory devices, one or more wireless transceivers and computer-readable instructions stored in the one or more memory devices. In embodiments, the computer-readable instructions are accessed from the one or more memory devices and are executable by the one or more processors to cause the mobile computing device to control two or more umbrellas and/or shading devices to perform operations and/or receive parameters or measurements. In embodiments, the mobile computing device communicates with web servers, application servers and/or database servers to execute and operate fleet management software (or multiple umbrella control software). In embodiments, the web servers, applications servers and/or database servers may each comprise one or more processors, one or more memory devices. In embodiments, the web servers, application servers and/or database servers may each include computer-readable instructions stored in the one or more memory devices which may be accessed from the one or more memory devices and executed by the one or more web servers, application servers and/or database servers to interface with the mobile computing device and operate and/or execute the fleet management software. In embodiments, different modules or portions of fleet management software (e.g., the computer-readable instructions) may be stored on the different computing devices (web servers, application servers and/or database servers as well as mobile computing devices).

FIG. 4A illustrates an initial selection screen in fleet management software according to embodiments. In embodiments, the fleet management software may allow a user or operator to communicate and/or transmit commands, instructions, messages and/or parameters to 1) specific shading device types 410; 2) operator selected groups 415 (which would have been already created); or 3) individual shading devices 420. In embodiments, the fleet management software may also allow a user to create 425 new groups of shading devices and/or edit existing groups of shading devices (although this option is not shown in FIG. 4A).

FIG. 4D illustrates an input screen for an operator to create one or more shading device groups according to embodiments. This is an important advantage SMARTSHADE software (or fleet management software) has in that a user or operator can configure the software to communicate with multiple devices at a time. In addition, because shading devices are portable, the shading devices may move to different areas and may then be placed into a different grouping. Thus, the ability to create new groups provides an advantage in dealing with environments where multiple shading devices may be utilized in different location. This improves the operation of the mobile computing device because the processors are not be utilized to execute software continuously as they would be if the software was only addressing one shading device at time. In embodiments, the computer-readable instructions executable by the processors (e.g., the fleet management portion of the SmartShade software) may generate a list of existing shading devices and present the list of existing shading devices on a screen of a mobile communications device. In embodiments, the fleet management portion of the Smartshade software may also present an input area for a user or operator to name the created shading device group. FIG. 4D provides an illustrative example of a “create shading group” screen. In embodiments, such as illustrated in FIG. 4D, a list of shading devices and locations may be provided along with a selection indicator. In embodiments, for example as illustrated in FIG. 4D, a list may include a Bloom shading device 447 (located at a patio area), a Sunflower shading device 446 (located at a pool), a Blossom shading device 445 (located at the patio area), a Blossom shading device 444 (located at a restaurant area), a Sunflower shading device 443 (located at a patio area), a Mimosa shading device 442 (located at a patio area) and/or a Bloom shading device 441 (located at a pool). In embodiments, a group name input 450 may be provided and in FIG. 4D, the shading group may be entitled “Patio Umbrellas.” In embodiments, a user or operator may identify which shading devices should be in a group by selecting an indicator box. In embodiments, such as FIG. 4D for example the Bloom shading device 447, the blossom shading device 445, the Sunflower shading device 443 and the Mimosa shading device 442 may be included in the newly created Patio Umbrellas groups. In embodiments, selections may be made via voice commands to the mobile communications device. In embodiments, selections may be made utilizing gesture recognition. In embodiments, the computer-readable instructions executable by the one or more processors in the mobile computing device (e.g., SMARTSHADE software or fleet management software) may retrieve, review and/or analyze a list of shading devices and determine shading devices that are similar and may automatically place the same or similar devices into groups based at least in parts on the analysis. In other words, the SMARTSHAD software or fleet management software may automatically create groupings on its own.

FIG. 4B illustrates a shading device type selection screen according to embodiments. In embodiments, if a user selects to communicate instructions, commands, messages and/or parameters to shading devices based upon groups of devices. In embodiments, for example, the SmartShade application servers and/or database servers may retrieve, if groups of devices are selected, and/or communicate or serve a web page or menu to the user computing device. In embodiments, the web page or menu identifies different types of shading devices that are available to be controlled. In FIG. 4B, for example, four shading device types (and thus groups) may be retrieved and presented (e.g., Bloom shading devices 430, Sunflower shading devices 431, Blossom shading devices 432, and/or Mimosa shading devices 433). In embodiments, a user may select a shading device group to which to communicate instructions, commands, messages and/or parameters. In embodiments, this selection may be made utilizing voice commands, tactile or keyboard input, touch screen input, automatic selection and/or gesture recognition. In embodiments, the selection message or instruction may be communicated to the SmartShade application server and/or database server and the application server and/or database server may retrieve and communicate a web page or similar menu to the user's computing device, In embodiments, the web page or menu may identify different methods of communicating the commands, messages, instructions, and/or parameters to the selected shading devices.

In embodiments, FIG. 4C illustrates different ways or processes for communicating commands, instructions, messages and/or parameters to the plurality of shading devices. In embodiments, the SMARTSHADE software (or fleet management software) may transmit or communicate individual device commands, instructions, messages and/or parameters; transmit commands, instructions, messages and/or parameters to a selected shading device type either simultaneously or sequentially; and/or transmit commands, instructions, messages and/or parameters to the selected shading device type in order for the shading devices to operate synchronously. In embodiments, as illustrated in FIG. 4C, if a user or operator selected Bloom Shading devices (see FIG. 4B), the fleet management software may retrieve a web page and/or menu from the application server and/or database server and may present shading device control options on a display of a computing device (e.g., such as a mobile computing device). In embodiments, for example, a user or operator may selected individual shading device control 434, group device control 435 and/or synchronized group control 436. In embodiments, if a user or operator selects individual shading device control 434, then commands, instructions, messages or parameters may be communicated to the selected individual shading device. In embodiments, if the user or operator selects group device control 435, the commands, instructions, messages or parameters may be communicated to a group of shading devices. In embodiments, if the user or operator selects synchronized group control 436, then the commands, instructions, messages or parameters may be communicated to the group of shading devices to make the shading devices to operate in a specific configuration and timed so that the group of shading devices perform operations simultaneously.

FIG. 4E illustrates another shading device control menu or web page for a selected shading device group according to embodiments. In embodiments, the fleet management software may allow a user and/or operator to broadcast commands to the selected group of shading devices. In embodiments, after a user or operator have selected a group name (e.g., selects “Patio Shades”), the fleet management software may retrieve and/or communicate and serve a web page and/or menu where the web page or menu identifies different shading device control options. In embodiments, as illustrated in FIG. 4E, a user or operator may select to communicate individual shading commands 452 to each individual shading device of the patio shades; broadcast shading commands 453 to the group of shading devices (e.g., “Patio Shades” group); timed shading commands 454 to the group of shading devices (e.g., “Patio Shades” group; or communicate different shade commands to different shading devices 455, but have the shading commands all entered and/or input at one time.

Broadcast Commands—In embodiments, if the user or operator may select to broadcast group shade commands, the fleet management software may receive the commands, instructions, messages or parameters that are to be communicated either via tactile input or voice input (or via other input devices of a mobile computing device). In embodiments, the fleet management computer-readable instructions may be executable by the one or more processors of the mobile computing device and may communicate the received and/or input commands, instructions, messages or parameters to the one or more wireless transceivers of the mobile computing device. In embodiments, the one or more wireless transceivers may communicate the received commands, instructions, messages or parameters to one or the one or more wireless transceivers of the selected one or more shading devices. In embodiments, the one or more wireless transceiver may communicate to each of the shading devices at the same time, or at close to the same time. In embodiments, in other words, the one or more wireless transceivers of the mobile communications device may make a broadcast transmission to two or more shading devices.

Timed Shading Commands—In embodiments, such as hotels, public gathering places, beaches, outdoor restaurants, etc., an owner or operator may own a number of shading devices and/or umbrellas. In embodiments, the owner or operator may not want to continuously move and/or adjust individual shading devices throughout the day in that it is not efficient and wastes employees' time. The shading devices may be located in different areas of a venue or area and thus may operate under different conditions. Thus, broadcasting the same commands, instructions, message or parameters at the same time may not be a desired sequence for the shading devices in these venues. In embodiments, a user and/or operator of one or more shading devices and/or umbrellas may communicate one or more sequences of timed commands to two or more shading devices. In embodiments, fleet management computer-readable instructions executable by one or more processors (e.g., fleet management software) may present a user or operator with a screen or menu to allow entering or submission of commands, instructions, messages and/or parameters that to be communicated to two or more shading devices. In embodiments, the fleet management computer-readable instructions executable by the one or more processors of the mobile communications device may also receive and/or prompt for a time of execution of the different sequences, strings or sets of commands, instructions, messages and/or parameters. In embodiments, this allows entrance of different execution times for the different shading devices. In embodiments, the fleet management computer-readable instructions (e.g., software) executable by the one or more processors of the mobile computing device may communicate the entered or selected sequences of commands, instructions, messages and/or parameters and/or execution timing parameters or values to the one or more wireless transceivers in the mobile communications device. In embodiments, the one or more wireless transceivers in the mobile communications device may communicate the received sequences of commands, instructions, messages and/or parameters and/or the execution timing parameters to the two or more shading devices. In embodiments, the two or more shading devices (e.g., computer-readable instructions executable by the one or more processors of the shading device) may each 1) receive the communicated sequences of commands, instructions, messages and/or parameters; 2) receive the execution timing parameters; and/or 3) may cause the shading device components, assemblies and/or systems to complete, at the received execution time values, the actions and/or operations identified in the received sequence of command, instructions, messages and/or parameters. This feature and/or capability allows for the mobile communication device (or other computing device) to be able to free up processing time because the mobile communication device (or other computing device) is not responsible to communicate the sequences commands, instructions, messages or parameters to the one or more shading devices at the different execution times. In embodiments, for example, in a same sequence of commands, an operator may send commands for a first shading device in a pool area to open the arms or blades, activate one or more environmental sensors and turn on the music at 10:00 am in a pool area and the first shading device may perform the operations at the requested execution time. In this illustrative embodiments, for example, the mobile communication device may also have communicated a second sequence of commands to a second shading device in a restaurant area to open the arms or blades, turn on lighting assemblies, turn on proximity sensors and/or also activate a camera to capture images and stream video starting at 11:00 am when the restaurant opens.

In embodiments, the user or operator of the fleet management software may able to control operations of a number of umbrellas by entering the sequences of commands, instructions, messages and/or parameters and letting the mobile communications device and/or fleet management software control the operations automatically based at least in part on the entered and then communicated commands. This is a big advantage as compared to communicating with each shading device individually and/or manually moving or adjusting the two or more shading devices to perform specific actions and/or operations. In an alternate embodiment, the fleet management software may receive the selected sequences of commands, instructions, messages and/or parameters as well as the execution timing values or measurements and may wait until the execution time (or close to the execution time) to communicate the selected sequence of commands, instructions, messages and/or parameters to the selected shading device to the one or more wireless transceivers of the mobile communications device and then to the selected and/or identified shading device. In embodiments, as was discussed above for example, the fleet management software may communicate the identified commands, instructions, messages or parameters to the pool shading device around 10:00 am and the identified commands, instructions, messages or parameters to the restaurant shading device around 11:00 am. This embodiment may be utilized when clocks and/or timers are not available in the shading devices receiving the commands and thus these devices cannot keep track of when to execute the received commands, instructions, messages and/or parameters. As is also illustrated in the example above, different sequences of selected commands, instructions, messages and/or parameters may be sent to different shading devices. This is a significant advantage in that it allows a user or operator to control two or more shading devices in different areas of a venue or operation.

Different shade commands to different shading devices 455 but have the shading commands all entered and/or input at one time. In embodiments, a commercial venue or park or a recreation center may have different areas which each have one or shading devices. In such embodiments, an owner or operator may wish to send different commands or sequences of commands to different shading devices or shading device groupings located in different parts of the commercial venue, park and/or recreation center. In embodiments, fleet management software may present a menu or screen to an owner, operator or user to enter shading devices (or grouping of shading devices) to receive selected commands, instructions, messages and/or parameters. In embodiments, the fleet management software may receive the selected commands, instructions, messages and/or parameters and may communicate the received commands, instructions, messages and/or parameters to the one or more wireless communication transceivers. As mentioned above, these may include different sets of commands, instructions, messages and/or parameters for different shading devices and/or groups. In other words, shading device A may receive command set A while shading device group B (with 3 shading devices) may receive command set B. In embodiments, included in the received commands, instructions, messages and/or parameters may be shading device identifiers or addresses to identify which shading device is to receive which selected commands, instructions, messages and/or parameters. In embodiments, the one or more wireless communication transceivers may communicate the one or more sequences of received commands, instructions, messages and/or parameters to the different identified shading devices and/or shading devices groupings. In embodiments, depending on the type or wireless communications protocol used, the one or more wireless communication device may communicate the received commands, instructions, messages and/or parameters to the different shading devices or shading device groupings simultaneously and/or in parallel. In other words, command and instruction set A may be communicated to a first shading device at the same time or in parallel with command and instruction set B being communicated to a second and third shading device. In some cases, PAN transceivers and/or WiFi or 802.11 transceivers may be able to communicate sequences of commands or command sets simultaneously. In embodiments, in an illustrative example, a recreation center may include a pool and outdoor changing area with one or more shading devices and picnic tables having three shading devices providing sun protection. In embodiments, during a party for example, a user or operator may desired to move people from the pool and changing area to the picnic tables. In this illustrative embodiment, for example, a user or operator (in a different part of the recreation center) may enter commands, instructions, and/or messages to 1) cause the one or more shading devices at the pool to close and may also play a recorded message indicating the pool portion of the party is now ending and to move to the picnic area for food; and 2) to open the three shading devices at the picnic tables and begin to play music at the three shading devices. In embodiments, the fleet management software, utilizing the one or more wireless transceivers, may communicate the first command sequences to the first shading device and may simultaneously communicate (or at the same time) the second command sequences to other three shading devices). In embodiments, the one or more wireless communication transceivers may communicate the one or more sequences of commands, instructions, messages and/or parameters sequentially to the different identified shading devices. In embodiments, sequential transmission or communication of commands, instructions, messages and/or parameters may occur due to limited bandwidth of the wireless network, limited availability or processing power of the mobile communication devices and/or other technical factors or considerations. Thus, utilizing the example above, the fleet management software may alternatively first communicate the selected sequence of commands to the pool shading device(s) and then sequentially communicate a different selected sequence of commands to the other three shading devices.

In embodiments, a mobile communications device or other computing device may include two or more wireless communication transceivers operating under different wireless communication protocols. In embodiments, in a venue or property or other area, a first group of shading devices may have only PAN wireless transceivers and a second group of shading devices may only have WiFi or 802.11 wireless communication transceivers. In embodiments, the fleet management software may automatically recognize these communication capabilities during initialization of a system and/or by attempting to establish communications between the mobile communications device (or other computing devices) and/or the shading devices. In embodiments, a user or operator may also enter this information into the fleet management software. In embodiments, a user or operator may also enter a preferred method of wireless communications between a mobile communications device and/or a phone in order to deal with bandwidth issues and/or cost issues. In embodiments, the fleet management software may store the wireless communication capability of the different shading devices in one or more memory devices of the mobile communications device and/or computing device. In embodiments, a user or operator may enter a first set of commands, instructions, parameters and/or messages for Shading Device Group A (a first and second shading device) and a second set of commands, instructions, parameters or messages for Shading Device Group B (a third and fourth shading device). In embodiments, the fleet management software may retrieve the communication capabilities for Shading Device Group A (e.g., a PAN wireless transceiver) and Shading Device Group B (e.g., a WiFi or 802.11 wireless transceiver). In embodiments, the fleet management software may communicate the first set of commands, instructions, messages and/or parameters to the PAN wireless transceiver which in turn communicates the first set of commands, instructions, messages and/or parameters to the PAN wireless transceivers in the first and second shading devices. Simultaneously (or sequentially), the fleet management software may communicate the second set of commands, instructions, messages and/or parameters to the third and fourth shading devices via the WiFi wireless transceiver. Again, this is a clear advantage over any known control of multiple shading objects because the fleet management software can control multiple shading objects even if the shading objects have different wireless communications protocols and/or transceivers. In embodiments, the fleet management software may be able to handle simultaneously communication to different shading devices via one or more wireless communication protocols, including, but not limited to DECT protocol, cellular communication protocols, WiFi or 802.11 protocols, personal area wireless network protocols (e.g., Bluetooth or Zigbee), low energy (e.g., BLE-Bluetooth Low Energy) wireless communication protocols and/or other protocols.

In embodiments, while the above description may include descriptions of communicating and/or transmitting sets or sequences of commands, instructions, messages and/or parameters, a user and/or operator may simultaneously or sequentially communicate commands, may communicate in a broadcast; or may communicate to individual shading devices one command (or one command to each shading device). The discussion above applies to communicating one command, multiple commands, sets of commands and/or sequences of commands to one or two or more shading devices. Likewise, in some circumstances, the term “command” is utilized alone and not with instructions, messages and/or parameters. In many cases, this is done to simplify and streamline the application and the term “command” may be substituted with instructions, messages and/or parameters. In other words, if the specification only refers to commands, then the actions may also be applied or utilized with respect to instructions, messages and/or parameters.

In embodiments, different computing devices and/or electronic devices may be able to control multiple shading devices or multiple groups of shading devices. While there has been a discussion regarding mobile communication devices (e.g., tablets, smartphones, mobile phones, wearable computing devices, and/or laptop computing devices) including fleet management software, the fleet management software may also be loaded and/or stored into memory devices and/or executable by one or more processors of different computing devices, such as desktop computing devices, server computing devices smart appliances, smart home devices, television controllers, home security devices and/or control panels and/or IoT-enabled computing devices. In embodiments, the listed devices above may communicate with and/or control one or more shading devices utilizing existing communication protocols utilized by the devices listed above. In embodiments, for example, desktop computing devices and/or server computing devices may utilize wired communication protocols and/or wireless communication protocols to communicate with the one or more shading devices. In embodiments, smart appliances, smart home devices, home security devices and/or IoT-enabled computing devices may communicate with and/or control operation of the one or more shading devices via various communication protocols, including but not limited to, Internet Protocol Version 6 (IPv6) communication protocol, over Low power Wireless Personal Area Networks (6LoWPAN) communication protocol, ZigBee communication protocol, Bluetooth Low Energy (BLE) communication protocol, Z-Wave communication protocol and Near Field Communication (NFC) communication protocol. In addition, IoT communication protocols may be short-range standard network protocols, while SigFox and Low Power Wide Area Network (LPWAN).standard protocols communication protocols.

FIG. 4F illustrates a screen of a mobile communication device operating fleet management software and receiving video or images from two or more shading devices according to embodiments. In embodiments, the fleet management software may receive communications back from two or more shading devices after initializing communicating commands, instructions, parameters and/or measurements to the two or more shading devices. In embodiments, for example, the commands, messages or instructions may request that the two or more shading devices communicate back video and/or images to allow a user or operator of the fleet management software of images of areas around the shading devices. In this illustrative embodiment, for example, the two or more shading devices may activate the cameras integrated within the two or more shading devices, which may communicate the images and/or video through the one or more wireless communication transceivers back to the mobile communication device (or other computing device). In embodiments, the one mobile communication device (or other computing device) may receive the images and/or video at its one of the one or more wireless communication transceivers and may transfer the images and/or video to a display of the mobile communications device as is shown in FIG. 4F. In FIG. 4F, the mobile communications device display 480 includes four display screens. In embodiments, the four display screens may include display screen 1 481 which displays images and/or video received from shading device 1; display screen 2 482 which displays images and/or video received from shading device 2; display screen 3 483 which displays images and/or video received from shading device 3; and/or display screen 4 484 which displays images and/or video received from shading device 4. This is an improvement over any existing shading devices systems. In embodiments, not only can the mobile communication device control operations of two or more shading devices, but the mobile communication device also receives live images and/or video from different shading devices located in different areas of a venue. This provides security benefits as well as allowing a user or operator to understand needs of customers at the different shading devices.

FIG. 4G illustrates a screen of a mobile communication device operating fleet management software and receiving status measurements and/or parameters from two or more shading devices according to embodiments. FIG. 4G illustrates three submenus 491 492 493 of a mobile communications device operating fleet management software. In embodiments, three shading devices communicate status measurements and/or parameters with the mobile communications device or other computing device and the mobile communications device displays the received information on its display in a menu 490. In embodiments, for example, fleet management submenu 491 displays illustrative status measurements and/or parameters received from the temperature sensor of shading device 1, the humidity sensor of shading device 1, the one or more motor assemblies of shading device 1 and/or the ultraviolet sensor of shading device 1. In embodiments, for example, fleet management submenu 492 displays illustrative status measurements and/or parameters received the temperature sensor of shading device 2, the wind sensor of shading device 2, and/or an operational status of GPS transceiver of shading device 2. In embodiments, for example, fleet management submenu 493 displays illustrative status measurements and/or parameters received from the temperature sensor of shading device 3, the air quality sensor of shading device 3 and/or from one or more wireless transceivers of shading device 3. These submenus are illustrative. In embodiments, the fleet management software may generate multiple submenus depending on the number of shading devices being controlled. In embodiments, the submenus may display status measurements and/or parameters from any number of components and/or assemblies. In embodiments, the submenus may display only status measurements that are above predetermined thresholds and/or in dangerous conditions. In embodiments, an operator and/or user may determine which status measurements and/or parameters are to be displayed in a submenu associated with a shading device. In embodiments, for example, an operator and/or user may set up the submenus to display the same measurements and/or parameters received from the same components and/or assemblies for each of the shading devices. In embodiments, an operator and/or user may setup submenus to display different measurements and/or parameters received from different components and/or assemblies in the different shading devices. In other words, the different submenus may display different readings or status indicators for each shading device, as is illustrated in FIG. 4G.

In embodiments, a mobile communications device (or other computing device) may receive touchscreen input to control operations and/or use of the fleet management software. In embodiments, the fleet management software may be operated utilizing voice recognition. In other words, the user may utilize voice commands to operate the fleet management software. In embodiments, the mobile communications device (or other computing device) may include voice recognition software to convert the spoken words into the commands, instructions, and/or messages communicated to the one or more shading devices. In embodiments, in order to execute the voice recognition software, the mobile communication device may transfer the received audio files (or text files) to a voice recognition server in a cloud-based server, which then communicates back commands, instructions and/or messages that may be communicated to the two or more shading devices to control operations, receive video and/or images from the two or more shading devices, and/or receive status parameters and/or messages from the two or more shading devices.

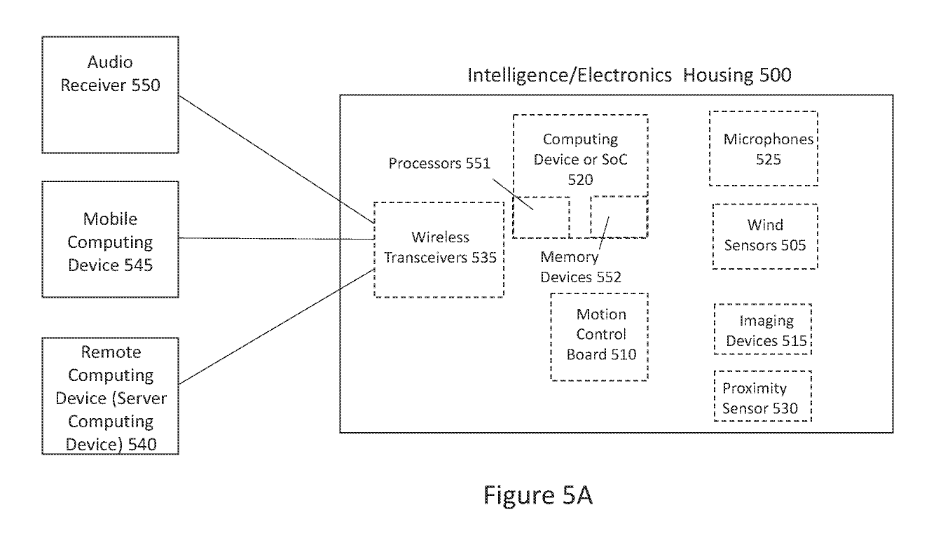

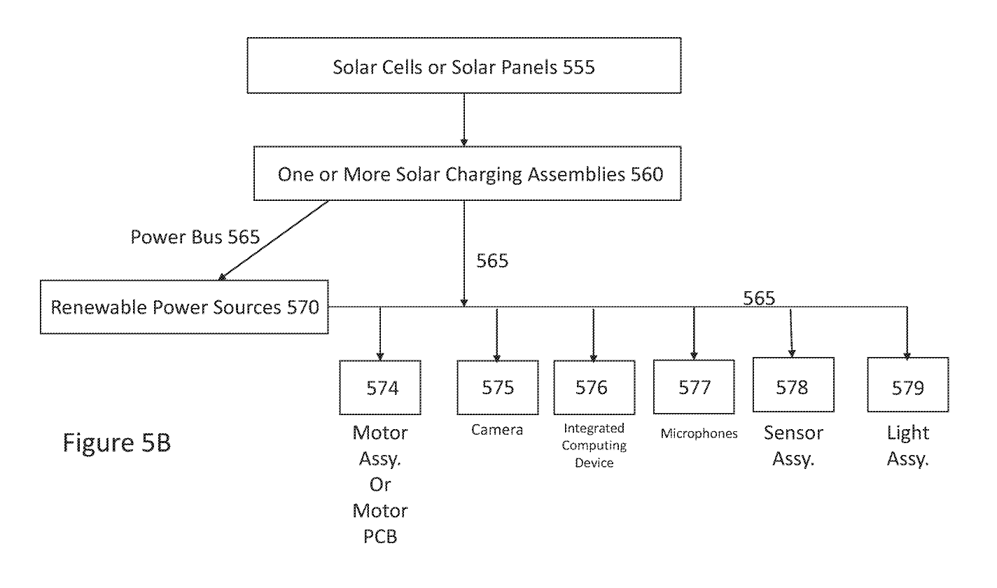

In embodiments, an umbrella, parasol and/or shading system may comprise an intelligence housing (e.g., a brain box) to control a number of functions and/or features of the umbrella, parasol or shading system. FIG. 5A illustrates a block diagram of an intelligence housing and components housed therein according to embodiments. In embodiments, an intelligence housing 500 may be manufactured utilizing additive manufacturing techniques (e.g., 3D printing). In embodiments an intelligence electronics housing may be made of plastic material, a composite material or a lightweight metal material or a combination thereof. In embodiments, an intelligent housing 500 may comprise one or more wind sensor assemblies 505, one or more motor control assemblies or motion control boards 510 (e.g., for controlling operation of, for example, an expansion motor), one or more imaging devices 515, one or more integrated computing devices (e.g., Raspberry Pi) or one or more systems-on-a-chip, one or more microphones or line arrays 525, one or more additional PAN transceivers (e.g. a Bluetooth transceiver), which also may be located in a speaker housing module, and one or more proximity sensors 530. In embodiments, an intelligence housing 500 may comprise one or more wireless communication transceivers 535. In embodiments, wireless communication transceivers 535 in an intelligence housing may communicate with one or more remote computing devices (e.g., one or more server or a cloud-based servers 540, one or more mobile computing devices 545 and/or one or more audio receivers 550. In embodiments, one or more systems-on-a chip (SoC) may comprise one or more processors or controllers 551, one or more memory devices 552, and/or one or more wireless transceivers 535 (e.g., one or more PAN transceivers (e.g., low energy BLE transceiver), one or more WiFi transceivers and/or one or more cellular transceivers). In embodiments, these components may also be located on separate circuit boards and/or physical structures.

FIG. 5B illustrates a block diagram power subsystem of a parasol, umbrella or shading system according to embodiments. In embodiments, a power subsystem comprises one or more solar cells, solar cell arrays or solar cell panels 555, one or more solar charging assemblies 560, one or more power buses 565, one or more rechargeable batteries 570, and one or more electrical or electro-mechanical assemblies 574 575 576 577 578 and 579. In embodiments, one or more solar cells, solar cell arrays or solar cell panels 555 may generate electrical energy or electrical power from a light source (e.g., the sun). In embodiments, one or more solar cells, solar cell arrays or solar cell panels 555 may transfer power or electrical energy to one or more solar charging assemblies 460. In embodiments, one or more solar charging assemblies 560 may be solar charge controllers or MPPT controller. In embodiments, one or more solar charging assemblies 560 may comprise computer interfaces that monitor and control power output from one or more solar cells, solar cell arrays and/or solar cell panels. In embodiments, indicators may monitor, control and/or display output power (e.g., one or more LED lighting assemblies 574 may show that power is being supplied and that some power is being output via a solar charging assembly 560). In embodiments, one or more solar charging assemblies 560 may also display voltage and/or current being supplied from one or more solar panels, solar cell arrays or solar cell panels 555 and/or may also display voltage and/or current being output by one or more solar charging assemblies 560 as well as displaying how much current is being pulled from a load terminal (and thus supplied to a rechargeable power source, components and/or assemblies).

In embodiments, one or more solar charging assemblies 560 may supply power to one or more rechargeable power sources (e.g., rechargeable batteries) 570. In embodiments, one or more solar charging assemblies 560 may supply power (e.g., voltage and/or current) to a power bus and/or power cables 565. In embodiments, the power supplied to a power bus and/or power cables 565 from one or more solar charging assemblies 460 may be at an approximate level of 12 volts (or between 11 to 17 volts). In embodiments, one or more solar charging assemblies 560 may provide power to a rechargeable power source 570 at a level between 11 and 17 volts (or at approximately 12 volts). In embodiments, a power bus and/or one or more power cables 565 may supply power (e.g., voltage and/or current) to one or more components, assemblies or apparatuses (e.g., one or more electrical or electro-mechanical assemblies 574 575 576 577 578 and 579). For example, electrical component 324 may be a motor control printed circuit board or a motor controller that causes a motor to expand one or more arms to deploy or retract; reference number 575 may be an integrated camera that captures images around an umbrella; reference number 576 may be an integrated computing device 576 that may include computer-readable instructions stored in one or more memory devices that are executable by one or more processors in the integrated computing device; reference number 577 may be one or more microphones (e.g., a microphone array to capture ambient noise as well as voice commands); reference number 578 may be one or more sensor assemblies or sensors (e.g., directional sensors, environmental sensors and/or proximity or motion sensors); and reference number 579 may be one or more lighting assemblies. In embodiments, an umbrella and/or parasol may not include or comprise all of the above-listed components. In embodiments, components such as a motor control PCB 574, one or more cameras 575, one or more integrated computing devices 576, one or microphones 577, one or more sensors or sensor assemblies 578, and one or more lighting assemblies 579 may not utilize 12 volts and if not then these components and/or assemblies may include a voltage regulator to provide a lower voltage, such as 3.3 Volts and/or 5 volts, that maybe utilized and/or required by these components. In embodiments, one or more renewable power sources (e.g., rechargeable batteries) 570 may be placed in a battery housing. In embodiments, one or more battery housings 570 may be placed around a center core assembly, as may be discussed in detail later.

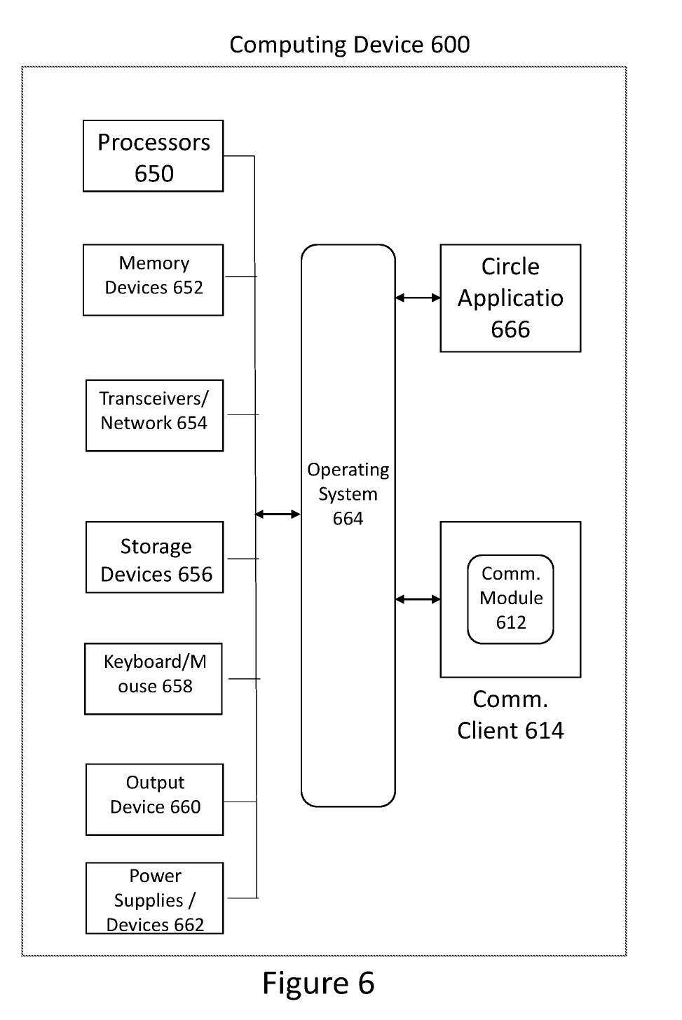

FIG. 6 illustrates a computing device according to embodiments. The computing device could be a mobile communications device, a server computing device, a mobile computing device, or other computing devices executing computer-readable instructions to run fleet management software. As shown in the specific example of FIG. 6, mobile computing device 600 includes one or more processors 650, one or more memory devices 652, one or more transceiver or communication network interfaces 654, one or more storage devices 656, one or more input devices 658, one or more output devices 660, and one or more power sources 662. Mobile communications device or computing device 600 may also include one or more operating systems 664 that are executable by mobile communications device or computing device 600. Mobile communications device or computing device 600, in one example, may further include communication client 612 and one or more application software including but not limited to SMARTSHADE or fleet management software 666 that are also executable by mobile communications device or computing device 600 (in conjunction with server software installed on one or more server computing devices). Each of components 650, 652, 654, 656, 658, 660, 662, 664, 666, and 612 may be interconnected (physically, communicatively, or operatively) for communications there between.

In embodiments, one or more processors 650, in one example, are configured to at least implement functionality or process instructions for execution within client device 610. For example, one or more processors 650 may be capable of processing instructions stored in one or more memory devices 652 or instructions stored on one or more storage devices 656.

In embodiments, one or more memory devices 652, in one example, is configured to store information within mobile communications device or computing device 600 during operation. One or more memory devices 652, in some examples, is described as a computer-readable storage medium. In some examples, one or more memory devices 652 may be used as a temporary memory, although one or more memory devices 652 may be used as long-term storage. In embodiments, one or more memory devices 652, in some examples, is described as a volatile memory, which may include random access memories (RAM), dynamic random access memories (DRAM), static random access memories (SRAM), and other forms of volatile memories known in the art. In some examples, one or more memory device 652 is used to store program instructions for execution by one or more processors 650. In embodiments, one or more memory devices 652, in one example, is used by software or applications running on mobile communications device or computing device 600 (e.g., application 666 and/or one or more other applications 614) to temporarily store information during program execution.

In embodiments, storage devices 656, in some examples, may also include one or more computer-readable storage media. In embodiments, storage devices 656 may be configured to store large amounts of information. In embodiments, storage devices 656 may further be configured for long-term storage of information. In some examples, storage devices 656 include non-volatile storage elements, including but not limited to magnetic hard discs, optical discs, floppy discs, flash memories, or forms of electrically programmable memories (EPROM) or electrically erasable and programmable (EEPROM) memories.

Mobile communications device or computing device 600, in some examples, also includes one or more transceivers or communication network interfaces 654. Mobile communications device or computing device 600 in one example, utilizes one or more wireless transceivers or communication network interfaces 654 to communicate with external devices via one or more networks, such as one or more wireless networks. One or more wireless transceivers or network interfaces 654 may be a network interface card, such as an Ethernet card, an optical transceiver, a radio frequency transceiver, a wireless transceiver, or any other type of device that can send and receive information. Other examples of such network interfaces and/or wireless transceivers may include Bluetooth, 3G, 4G, BLE, NFC, and WiFi radios in mobile computing devices. In embodiments, USB may be a network interface. In some examples, mobile communications device or computing device 600 utilizes one or more communication and network interfaces 654 to wirelessly communicate with an external device such as a server device or server computing device, a mobile phone, or other networked computing devices.

Mobile communications device or computing device 600, in one example, also includes one or more input devices 658. Input devices 658, in some examples, are configured to receive input from a user through tactile, audio, or video input, such as a touch screen, a mouse, a keyboard, a voice response or recognition system, a video camera, a microphone, a gesture recognition system or any other type of device for detecting a command from a user. In embodiments, one or more output devices 660 may also be included in mobile communications device or computing device 600. In embodiments, output device 660, in some examples, may be configured to provide output to a user using tactile, audio, or video output. In embodiments, output devices 660 may utilize a sound card, a video graphics adapter card, or any other type of device for converting a signal into an appropriate form understandable to humans or machines. In embodiments, additional examples of output devices 660 may include a speaker, a cathode ray tube (CRT) monitor, a liquid crystal display (LCD) screen, a mobile device screen and/or a LED display, or any other type of device that can generate recognizable output to a user.

In embodiments, mobile communications device or computing device 600, in some examples, may include one or more power sources or power supplies 662, which may be rechargeable and provide power to mobile communications device or computing device 600. In embodiments, the one or more power sources or power supplies 662 may be rechargeable and may be one or more rechargeable batteries. In embodiments, the one or more batteries may be made from nickel-cadmium, lithium-ion, or any other suitable material. In another example, in embodiments, the one or more power sources or power supplies 662 may include a power supply connection that receives power from a power source external to mobile communications device or computing device 600. The one or more power sources or power supplies 662 may provide less power to communication client 612 when the virtual communication session is in an inactive, or ambient state, than when the virtual communication session is in an active state than when it is in an inactive state.

In embodiments, one or more application software packages or modules 666 may provide mobile communications device or computing device 600 with additional functionality. In embodiments, an application software package may include a SMARTSHADE or fleet management application software. In embodiments, this additional functionality may include, for example, a social media application, web browsing, calendar, contacts, games, document processing, or any other functionality performed by a computing device such as mobile communications device or computing device 600. In embodiments, one or more software application packages 666 may cause at least one of output devices 660 to display some elements of a graphical user interface (GUI) or output via a sound reproduction assembly. In embodiments, mobile communications device or computing device 600 may include one or more operating systems 664. Operating systems 664, in some examples, may control the operation of components of mobile communications device or computing device 600. For example, operating system 664, in one example, may facilitate the interaction of communication client 612 with one or more processors 650, one or more memory device 652, wireless communication transceivers or network interfaces 654, one or more storage devices 656, input devices 658, output devices 660, and power sources or power supplies 662. In embodiments, communication client 612 may include communication module 614. In embodiments, one or more software applications 666 (including the SMARTSHADE or fleet management software application, communications client 612, and communication module 614 may each include at least one of computer-readable program instructions or data that are executable by one or more processors 650 of a mobile communications device or computing device 600. For example, in embodiments, communication module 614 may include computer-readable instructions executable by one or more processors 650 that cause communication client 612 to perform one or more of the operations and actions described in the present disclosure.

In some examples, in embodiments, at least one of application software packages 666, communication client 612, or communication module 614 may be a part of one or more operating systems 664 operating and being executed by one or more processors 650 of a mobile communications device or computing device 600. In some examples, in embodiments, communication client 612 may receive input from one or more input devices 658 of mobile communications device or computing device 600. In embodiments, communication client 612 may, for example, receive at least one of audio or video information associated with a communication session from other computing devices participating in the communication session.

In embodiments, communications between a mobile computing device or computing device and/or another computing device, a network device, one or more shading devices and a wireless network may be in accordance with known and/or to be developed communication network protocols including, for example, global system for mobile communications (GSM), enhanced data rate for GSM evolution (EDGE), 802.11b/g/n, WiFi, and/or worldwide interoperability for microwave access (WiMAX), as well as personal area network protocols including but not limited to Bluetooth, Zigbee, Bluetooth Low Energy (BLE), Z-Wave, DECT ULE and/or other local wireless network communication protocols. In embodiments, a mobile computing device or a computing device and/or a networking device may also have a subscriber identity module (SIM) card, which, for example, may comprise a detachable smart card that is able to store subscription content of a user, and/or is also able to store a contact list of the user. In embodiments, a user may own a mobile computing device or a computing device and/or networking device or may otherwise be a user, such as a primary user, for example. In embodiments, a mobile computing device or computing device may be assigned an address by a wireless network operator, a wired network operator, and/or an Internet Service Provider (ISP). For example, an address may comprise a domestic or international telephone number, an Internet Protocol (IP) address, and/or one or more other identifiers. In other embodiments, a communication network may be embodied as a wired network, wireless network, or any combinations thereof. In embodiments, communications between a mobile computing device or computing device and/or a network device and a wireless network may be in accordance with known and/or to be developed communication network protocols including, for example, global system for mobile communications (GSM), enhanced data rate for GSM evolution (EDGE), 802.11b/g/n, WiFi, a worldwide interoperability for microwave access (WiMAX), and/or personal area network (PAN) wireless protocols, as discussed above. In other embodiments, a communication network may be embodied as a wired network, wireless network, or any combinations thereof

The invention as described in this document has been do so in an illustrative manner. As such it is understood that any terminology or examples used in this application are intended to help clarify the invention and provide additional description. In no way does the terminology or examples limit the invention. Many modifications and variations of the present invention are possible in light of the above teachings

Aspects of the present disclosure may improve social interaction because users may indicate when they are actually available to engage in a communication session. In addition, the richness of the communicated reactions, e.g., video or audio representations of user expressions, may further improve the social interaction because such representations may convey more information with less user effort. The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), flash memory, magnetic or optical data storage media, and the like. In some examples, an article of manufacture may comprise one or more computer-readable storage media. In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

The above disclosure is sufficient to enable one of ordinary skill in the art to practice the invention, and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A mobile communications device to control two or more umbrellas, comprising:
one or more wireless transceivers, the one or more wireless transceivers to transmit commands, instructions or messages to two or more umbrellas and to receive commands, instructions, measurements, parameters or messages from the two or more umbrellas;
one or more processing devices;
one or more memory devices;
computer-readable instructions stored in the one or more memory devices, accessed from the one or more memory devices and executable by the one or more or processors to:
create a list of umbrellas associated with the mobile communications device;
receive a selection of at least a first umbrella and a second umbrella to be assigned as a first umbrella group;
assign the first umbrella and the second umbrella as the first umbrella group;
receive a selection of commands, instructions, parameters or messages to be communicated to the first umbrella group; and
communicate, via a wireless transceiver of the one or more wireless transceivers the selected commands, parameters, instructions or messages to a first umbrella and to a second umbrella.

2. The mobile communication device of claim 1, wherein the selected commands, parameters, instructions or messages comprise a first set of selected commands, parameters, instructions or messages that are communicated to the first umbrella and a second set of selected commands, parameters, instructions or messages that are communicated to the second umbrella, wherein the first set of selected commands, parameters, instructions or messages are different in content from the second set of selected commands, parameters, instructions or messages.

3. The mobile communication device of claim 1, wherein the selected commands, parameters, instructions or messages comprise a first set of selected commands, parameters, instructions or messages that are communicated to the first umbrella and a second set of selected commands, parameters, instructions or messages that are communicated to the second umbrella, where the first set of commands, parameters, instructions or messages and the second set of commands, parameters, instructions or messages have the same content and cause the first umbrella and the second umbrella to perform actions simultaneously.

4. The mobile communications device of claim 1, wherein the selected commands, parameters, instructions or messages comprise a first set of selected commands, parameters, instructions or messages that are communicated to the first umbrella and a second set of selected commands, parameters, instructions or messages that are communicated to the second umbrella, where the second set of commands, parameters, instructions or messages has a different execution time from the first set of the commands, parameters, instructions or messages, which causes the second umbrella to perform actions after the first umbrella performs actions.

5. The mobile communication device of claim 1, the computer-readable instructions executable by the one or more processors to cause the mobile device to receive voice commands to select the first umbrella and the second umbrella as the first umbrella group.

6. The mobile communications device of claim 5, the computer-readable instructions executable by the one or more processors to cause the mobile device to receive voice commands to select the commands, instructions, parameters or messages to be communicated to the first umbrella group.

7. The mobile communications device of claim 1, wherein the list of umbrellas associated with the mobile communications device is retrieved from one or the one or more memory devices of the mobile communications device.

8. The mobile communications device of claim 1, wherein the list of umbrellas associated with the mobile communications device is created in response to the mobile communications device communicating with the two or more umbrellas and receiving configuration parameters and information from the two or more umbrellas.

9. The mobile communications device of claim 1, the computer-readable instructions executable by the one or more processors to receive status messages from components or assemblies of at least one of the two or more umbrellas and to display the received status messages in a window of the screen of the mobile communications device.

10. The mobile communications device of claim 1, wherein the commands, instructions, messages or parameters include commands or instructions to activate a camera on a first umbrella to capture images of an area around the first umbrella and communicate the captured images, and computer-readable instructions executable by the one or more processors to receive, via the wireless transceiver, video or images from the camera of the first umbrella.

11. The mobile communications device of claim 1, the computer-readable instructions executable by the one or more processors to cause the mobile communications device to display the received video or images in a window on the screen of the mobile communications device.

12. A mobile communications device to control two or more umbrellas, comprising:
one or more wireless transceivers, the one or more wireless transceivers to transmit commands, instructions or messages to at least one umbrella and to receive commands, instructions, measurements, parameters or messages from the at least one umbrella;
one or more processing devices;
one or more memory devices;
computer-readable instructions stored in the one or more memory devices, accessed from the one or more memory devices and executable by the one or more or processors to:
retrieve a list of umbrellas associated with the mobile communications device;
receive a selection of at least a first umbrella and a second umbrella to be assigned as a first umbrella group;
assign the first umbrella and the second umbrella as the first umbrella group;
receive a selection of commands, instructions, parameters or messages to be communicated to the first umbrella group, the selection of commands including a first set of commands, instructions, parameters or messages to be communicated to the first umbrella and a second set of commands, instructions, parameters or messages to be communicated to the second umbrella;
communicate, via a first wireless transceiver of the one or more wireless transceivers, the first set of commands, parameters, instructions or messages to the first umbrella' and
communicate, via a second wireless transceiver of the one or more wireless transceivers, the second set of commands, parameters, instructions or messages to the second umbrella.

13. The mobile communication device of claim 12, the computer-readable instructions executable by the one or more processors to cause the mobile communications device to receive voice commands to select the first umbrella and the second umbrella as the first umbrella group or to receive voice commands to select the commands, instructions, parameters or messages to be communicated to the first umbrella group.

14. The mobile communications device of claim 12, wherein the list of umbrellas associated with the mobile communications device is retrieved from one or the one or more memory devices of the mobile communications device.

15. The mobile communications device of claim 12, wherein the list of umbrellas associated with the mobile communications device is created in response to the mobile communications device communicating with the two or more umbrellas and receiving configuration parameters and information from the two or more umbrellas.

16. The mobile communications device of claim 12, the computer-readable instructions executable by the one or more processors to receive status messages from components or assemblies of at least one of the two or more umbrellas and to display the received status messages in a window of the screen of the mobile communications device.

17. The mobile communications device of claim 12, wherein the commands, instructions, messages or parameters include commands or instructions to activate a camera on a first umbrella to capture images of an area around the first umbrella and communicate the captured images, and computer-readable instructions executable by the one or more processors to receive, via the wireless transceiver, video or images from the camera of the first umbrella and to display the received video or images in a window on the screen of the mobile communications device.

18. A mobile communications device to control two or more umbrellas, comprising:
one or more wireless transceivers, the one or more wireless transceivers to transmit commands, instructions or messages to at least one umbrella and to receive commands, instructions, measurements, parameters or messages from the at least one umbrella;
one or more processing devices;
one or more memory devices;
computer-readable instructions stored in the one or more memory devices, accessed from the one or more memory devices and executable by the one or more or processors to:
retrieve a list of umbrellas associated with the mobile communications device;
analyze the list of umbrellas associated with the mobile communications device and create one or more groups of umbrellas based at least in part on an umbrella model, an umbrella type or an umbrella location;
assign a first umbrella and a second umbrella as a first umbrella group of the one or more created groups of umbrella;
receive a selection of commands, instructions, parameters or messages to be communicated to the first umbrella group; and
communicate, via a wireless transceiver of the one or more wireless transceivers the selected commands, parameters, instructions or messages to a first umbrella and to a second umbrella.

19. The mobile communications device of claim 18, the computer-readable instructions executable by the one or more processors to cause the mobile device to receive voice commands to select the commands, instructions, parameters or messages to be communicated to the first umbrella group.

20. The mobile communications device of claim 12, wherein the commands, instructions, messages or parameters include commands or instructions to activate a camera on a first umbrella to capture images of an area around the first umbrella and communicate the captured images, and computer-readable instructions executable by the one or more processors to receive, via the wireless transceiver, video or images from the camera of the first umbrella and to display the received video or images in a window on the screen of the mobile communications device.
